(19) United States
(12) Patent Application Publication
(10) Pub. No.: US 2026/0039350 A1
(43) Pub. Date: Feb. 5, 2026

(54) CSI MEASUREMENT AND REPORTING

(71) Applicant: Samsung Electronics Co., Ltd., Suwon-si (KR)

(72) Inventors: Md. Saifur Rahman, Plano, TX (US); Eko Onggosanusi, Coppell, TX (US); Marian Rudolf, Longueuil (CA)

(21) Appl. No.: 19/267,334

(22) Filed: Jul. 11, 2025

Related U.S. Application Data
(60) Provisional application No. 63/678,382, filed on Aug. 1, 2024.
(60) Provisional application No. 63/684,167, filed on Aug. 16, 2024.

(51) Int. Cl. H04B 7/06; H04B 17/318; H04W 24/10

(52) U.S. Cl. CPC H04B 7/0626; H04B 17/328; H04W 24/10

(57) ABSTRACT

Apparatuses and methods for channel state information (CSI) measurement and reporting. A method performed by a user equipment (UE) includes receiving a configuration about a CSI report. The configuration includes information about K measurement resources and a report quantity that corresponds to a cross-link interference (CLI) metric. The method further includes measuring the K measurement resources, determining the CLI metric based on the measurement, and transmitting the CSI report including N indicators. Each of the N indicators indicate a respective value of the CLI metric. Each of the K measurement resources is a sounding reference signal (SRS) resource or received signal strength indicator (RSSI) measurement resource. The CLI metric is a layer 1 (L1) SRS-reference signal receive power (RSRP) value when each of the K measurement resources is the SRS resource or a L1 CLI-RSSI value when each of the K measurement resources is the RSSI measurement resource.

### CROSS-REFERENCE TO RELATED AND CLAIM OF PRIORITY

The present application claims priority under 35 U.S.C. § 119(e) to U.S. Provisional Patent Application No. 63/678,382 filed on Aug. 1, 2024 and U.S. Provisional Patent Application No. 63/684,167 filed on Aug. 16, 2024, which are hereby incorporated by reference in their entirety.

### TECHNICAL FIELD

The present disclosure relates generally to wireless communication systems and, more specifically, the present disclosure is related to apparatuses and methods for channel state information (CSI) measurement and reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to CSI measurement and reporting.

In one embodiment, a user equipment (UE) is provided. The UE includes a transceiver configured to receive a configuration about a CSI report. The configuration includes information about K measurement resources and a report quantity. K≥1 and the report quantity corresponds to a cross-link interference (CLI) metric. The UE further includes a processor operably coupled to the transceiver. The processor, based on the configuration, is configured to measure the K measurement resources and determine the CLI metric based on the measurement. The transceiver is further configured to transmit the CSI report including N indicators, each of the N indicators indicating a respective value of the CLI metric. N≥1. Each of the K measurement resources is one of a sounding reference signal (SRS) resource or received signal strength indicator (RSSI) measurement resource. The CLI metric is a layer 1 (L1) SRS-reference signal receive power (RSRP) value when each of the K measurement resources is the SRS resource or a L1 CLI-RSSI value when each of the K measurement resources is the RSSI measurement resource.

In another embodiment, a base station (BS) is provided. The BS includes a processor and a transceiver operably coupled to the processor. The transceiver is configured to transmit a configuration about a CSI report and receive the CSI report including N indicators. The configuration including information about K measurement resources and a report quantity, where K≥1 and the report quantity corresponds to a CLI metric. Each of the N indicators indicating a respective value of the CLI metric, the CLI metric based on the K measurement resources. Each of the K measurement resources is a SRS resource or a RSSI measurement resource. The CLI metric is a L1 SRS-RSRP value when each of the K measurement resources is the SRS resource or a L1 CLI-RSSI value when each of the K measurement resources is the RSSI measurement resource.

In yet another embodiment, a method performed by a UE is provided. The method includes receiving a configuration about a CSI report. The configuration includes information about K measurement resources and a report quantity, where K≥1 and the report quantity corresponds to a CLI metric. The method further includes measuring the K measurement resources, determining the CLI metric based on the measurement, and transmitting the CSI report including N indicators. Each of the N indicators indicate a respective value of the CLI metric. Each of the K measurement resources is a SRS resource or a RSSI measurement resource. The CLI metric is a L1 SRS-RSRP value when each of the K measurement resources is the SRS resource or a L1 CLI-RSSI value when each of the K measurement resources is the RSSI measurement resource.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates a diagram of example radio access network (RAN) configurations according to embodiments of the present disclosure;

FIG. 11 illustrates a diagram of example functional split points/options according to embodiments of the present disclosure;

FIG. 12 illustrates an example of a fully digital transmitter structure for beamforming according to embodiments of the present disclosure;

FIG. 13 illustrates a diagram of an example antenna port layout according to embodiments of the present disclosure;

FIG. 14 illustrates a timeline of example spatial-domain (SD) units and frequency-domain (FD) units according to embodiments of the present disclosure;

FIG. 15 illustrates an example port group (PG) according to embodiments of the present disclosure;

FIG. 16 illustrates examples of narrow/wide and co-located/non-co-located ports/PGs according to embodiments of the present disclosure;

FIG. 17 illustrates examples of channel measurement configurations according to embodiments of the present disclosure;

FIG. 18 illustrates an example a codebook configuration according to embodiments of the present disclosure;

FIG. 19 illustrates an example open RAN (O-RAN) architecture according to embodiments of the present disclosure;

FIG. 20 illustrates examples of spatial domain (SD) vector patterns according to embodiments of the present disclosure;

FIG. 21 illustrates a timeline of example time division duplexing (TDD) according to embodiments of the present disclosure;

FIG. 22 illustrates timelines of example TDD according to embodiments of the present disclosure;

FIG. 23 illustrates examples of interferences according to embodiments of the present disclosure;

FIG. 24A illustrates an example of non-duplex architecture according to embodiments of the present disclosure;

FIGS. 24B and 24C illustrate examples of duplex architecture according to embodiments of the present disclosure;

FIG. 25 illustrates an example of UE-to-UE CLI according to embodiments of the present disclosure;

FIG. 26 illustrates examples of CLI report triggers according to embodiments of the present disclosure; and

FIG. 27 illustrates an example method performed by a UE in a wireless communication system according to embodiments of the present disclosure.

### DETAILED DESCRIPTION

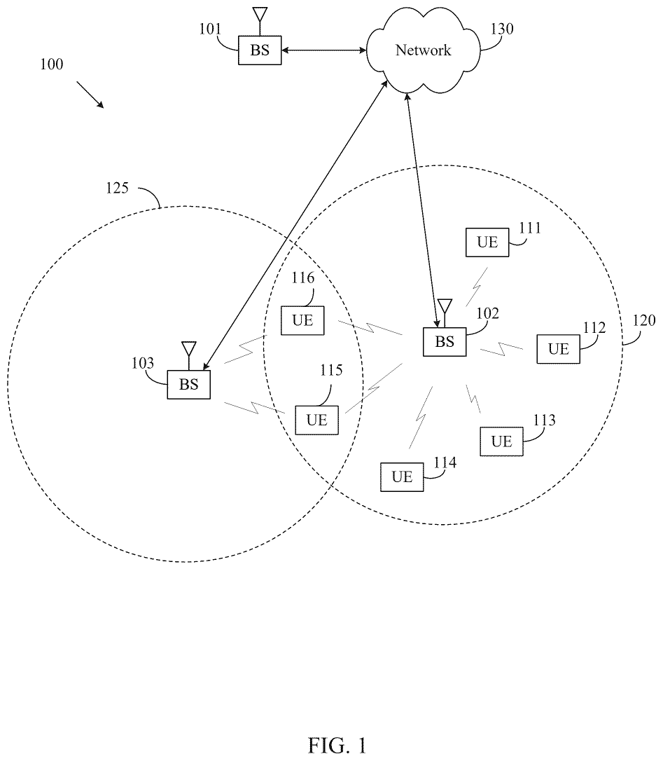

FIGS. 1-26 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

In the 5G system, Hybrid frequency shift keying (FSK) and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 36.211 v17.3.0, “E-UTRA, Physical channels and modulation;” [REF 2]3GPP TS 36.212 v17.3.0, “E-UTRA, Multiplexing and Channel coding;” [REF 3]3GPP TS 36.213 v17.3.0, “E-UTRA, Physical Layer Procedures;” [REF 4]3GPP TS 36.321 v17.3.0, “E-UTRA, Medium Access Control (MAC) protocol specification;” [REF 5]3GPP TS 36.331 v17.3.0, “E-UTRA, Radio Resource Control (RRC) Protocol Specification;” [REF 6]3GPP TR 22.891 v1.2.0; [REF 7]3GPP TS 38.212 v18.0.0, “E-UTRA, NR, Multiplexing and Channel coding;” [REF 8]3GPP TS 38.214 v18.0.0, “E-UTRA, NR, Physical layer procedures for data;” [REF 9]3GPP TS 38.211 v18.0.0, “E-UTRA, NR, Physical channels and modulation;” [REF 10] 3GPP TS 38.104 v18.3.0, “E-UTRA, NR, Physical channels and modulation;” [REF 11]0-RAN.WG4.CONF.0-R003-v09.00, “O-RAN Working Group 4 (Fronthaul Working Group) Conformance Test Specification;” and [REF 12] O-RAN.WG4.CUS.0-R003-v13.00, “O-RAN Working Group 4 (Open Fronthaul Interfaces WG)—Control, User and Synchronization Plane Specification.

FIGS. 1-26 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof to perform CSI measurement and reporting. In certain embodiments, one or more of the BSs 101-103 include circuitry, programing, or a combination thereof to support CSI measurement and reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

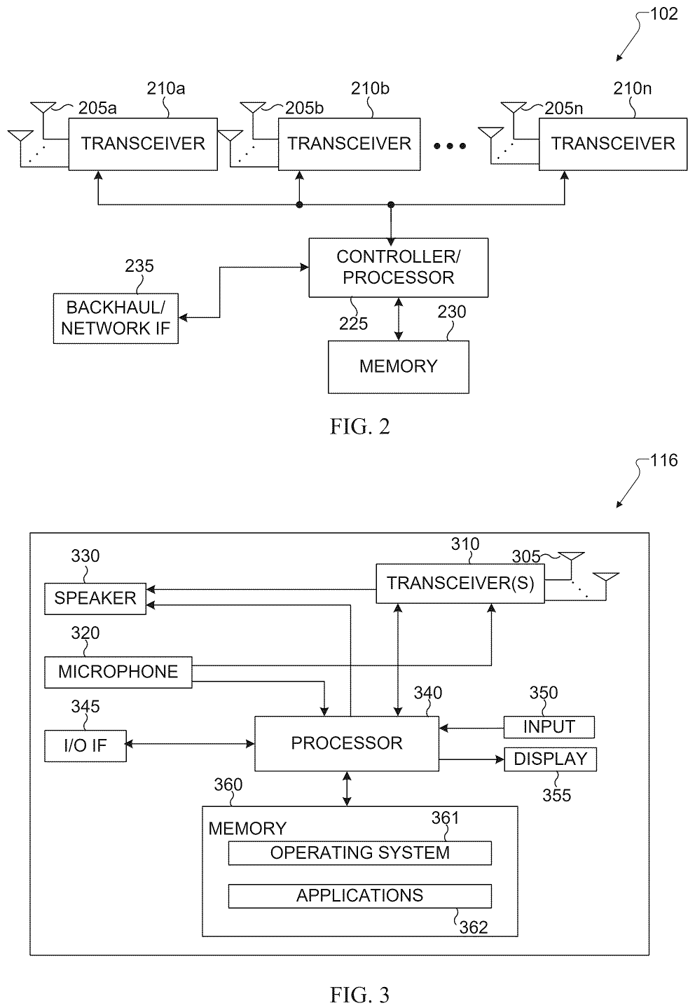

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for CSI measurement and reporting. Any of a wide variety of other functions could be supported in the gNB 102 by the controller/processor 225.

The controller/processor 225 is also capable of executing programs and other processes resident in the memory 230, such as processes to support CSI measurement and reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of uplink (UL) channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for CSI measurement and reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

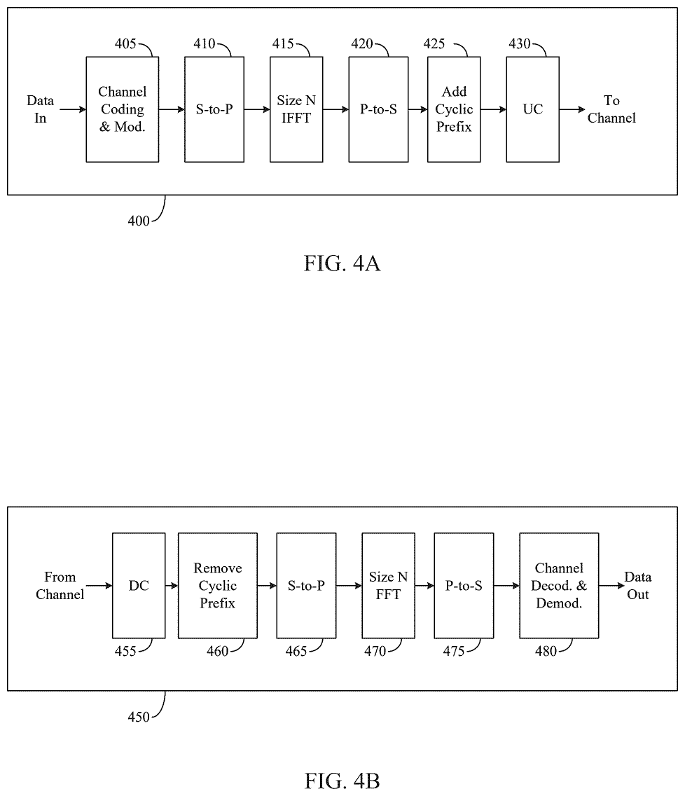

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured for CSI measurement and reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

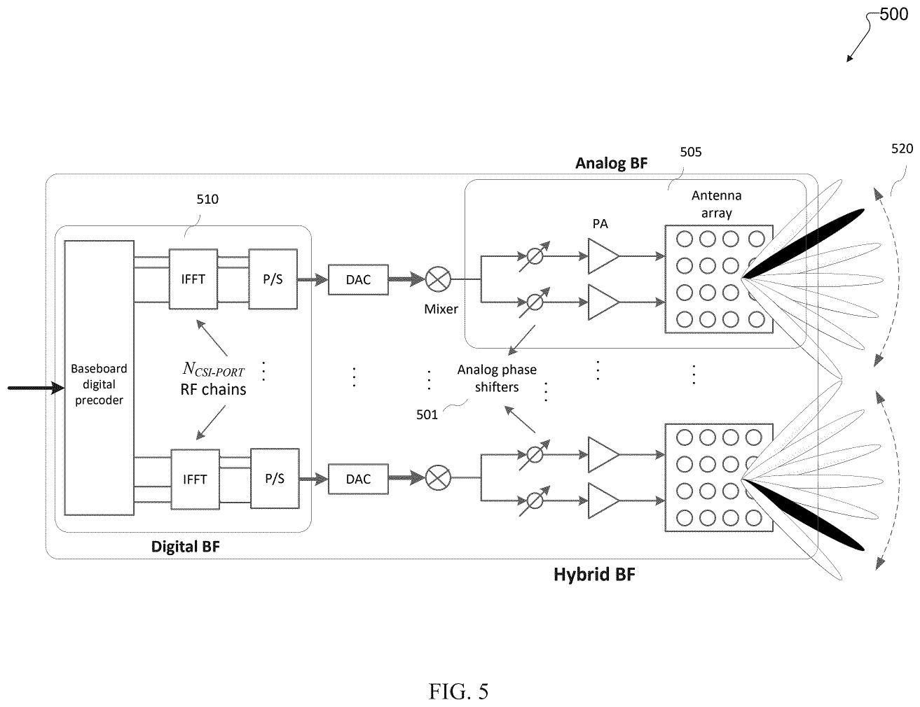

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state indication/information CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

The present disclosure relates generally to wireless communication systems and, more specifically, to efficient measurement in next generation of MIMO systems.

A communication system includes a DownLink (DL) that conveys signals from transmission points such as Base Stations (BSs) or NodeBs to User Equipments (UEs) and an UpLink (UL) that conveys signals from UEs to reception points such as NodeBs. A UE, also commonly referred to as a terminal or a mobile station, may be fixed or mobile and may be a cellular phone, a personal computer device, or an automated device. An eNodeB, which is generally a fixed station, may also be referred to as an access point or other equivalent terminology. For LTE systems, a NodeB is often referred as an eNodeB.

In a communication system, such as LTE, DL signals can include data signals conveying information content, control signals conveying DL Control Information (DCI), and Reference Signals (RS) that are also known as pilot signals. An eNodeB transmits data information through a Physical DL Shared CHannel (PDSCH). An eNodeB transmits DCI through a Physical DL Control CHannel (PDCCH) or an Enhanced PDCCH (EPDCCH)—see also REF 3. An eNodeB transmits acknowledgement information in response to data Transport Block (TB) transmission from a UE in a Physical Hybrid automatic repeat request (ARQ) Indicator CHannel (PHICH). An eNodeB transmits one or more of multiple types of RS including a UE-Common RS (CRS), a Channel State Information RS (CSI-RS), or a DeModulation RS (DMRS). A CRS is transmitted over a DL system BandWidth (BW) and can be used by UEs to obtain a channel estimate to demodulate data or control information or to perform measurements. To reduce CRS overhead, an eNodeB may transmit a CSI-RS with a smaller density in the time and/or frequency domain than a CRS. DMRS can be transmitted only in the BW of a respective PDSCH or EPDCCH and a UE can use the DMRS to demodulate data or control information in a PDSCH or an EPDCCH, respectively. A transmission time interval for DL channels is referred to as a subframe (or slot) and can have, for example, duration of 1 millisecond.

DL signals also include transmission of a logical channel that carries system control information. A broadcast control channel (BCCH) is mapped to either a transport channel referred to as a Broadcast CHannel (BCH) when it conveys a Master Information Block (MIB) or to a DL Shared CHannel (DL-SCH) when it conveys a System Information Block (SIB)—see also REF3 and REF 5. Most system information is included in different SIBs that are transmitted using DL-SCH. A presence of system information on a DL-SCH in a subframe (or slot) can be indicated by a transmission of a corresponding PDCCH conveying a codeword with a cyclic redundancy check (CRC) scrambled with a special System Information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe (or slot) and a group of Physical resource blocks (PRBs). A transmission BW includes of frequency resource units referred to as Resource Blocks (RBs). Each RB includes of N_{sc}^{RB} sub-carriers, or Resource Elements (REs), such as 12 REs. A unit of one RB over one subframe (or slot) is referred to as a PRB. A UE can be allocated M_{PDSCH} RBs for a total of M_{sc}^{PDSCH}=M_{PDSCH}·N_{sc}^{RB} REs for the PDSCH transmission BW.

UL signals can include data signals conveying data information, control signals conveying UL Control Information (UCI), and UL RS. UL RS includes DMRS and Sounding RS (SRS). A UE transmits DMRS only in a BW of a respective PUSCH or PUCCH. An eNodeB can use a DMRS to demodulate data signals or UCI signals. A UE transmits SRS to provide an eNodeB with an UL CSI. A UE transmits data information or UCI through a respective Physical UL Shared CHannel (PUSCH) or a Physical UL Control CHannel (PUCCH). If a UE needs to transmit data information and UCI in a same UL subframe (or slot), it may multiplex both in a PUSCH. UCI includes Hybrid Automatic Repeat reQuest ACKnowledgement (HARQ-ACK) information, indicating correct (ACK) or incorrect (NACK) detection for a data TB in a PDSCH or absence of a PDCCH detection (DTX), Scheduling Request (SR) indicating whether a UE has data in its buffer, Rank Indicator (RI), and Channel State Information (CSI) enabling an eNodeB to perform link adaptation for PDSCH transmissions to a UE. HARQ-ACK information is also transmitted by a UE in response to a detection of a PDCCH/EPDCCH indicating a release of semi-persistently scheduled PDSCH (see also REF 3).

An UL subframe (or slot) includes two slots. Each slot includes N_{symb}^{UL} symbols for transmitting data information, UCI, DMRS, or SRS. A frequency resource unit of an UL system BW is a RB. A UE is allocated N_{RB} RBs for a total of N_{RB}·N_{sc}^{RB} REs for a transmission BW. For a PUCCH, N_{RB}=1. A last subframe (or slot) symbol can be used to multiplex SRS transmissions from one or more UEs. A number of subframe (or slot) symbols that are available for data/UCI/DMRS transmission is N_{symb}=2·(N_{symb}^{UL}−1)−N_{SRS}, where N_{SRS}=1 if a last subframe (or slot) symbol is used to transmit SRS and N_{SRS}=0 otherwise.

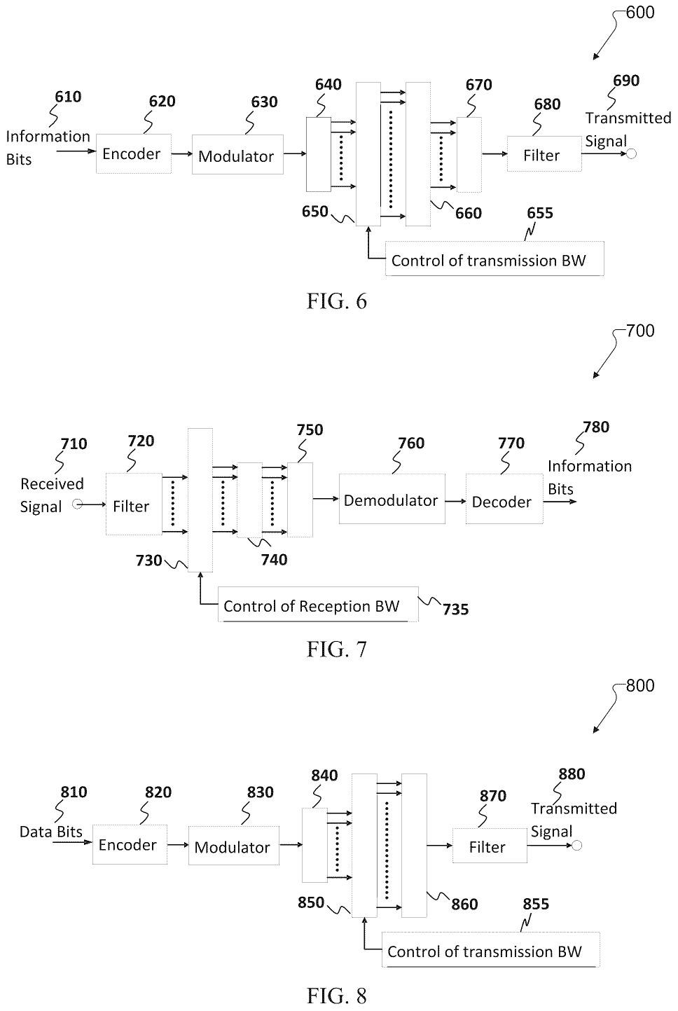

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a DMRS or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

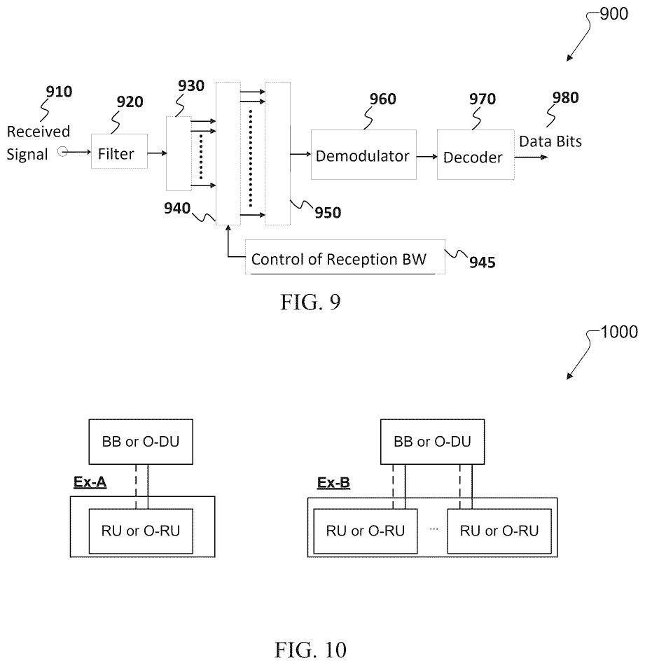

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown herein.

TABLE A

| Frequency range designation | Corresponding frequency range |
|---|---|
| FR1 | 450 MHz-600 MHz |
| FR2 | 24250 MHz-52600 MHz |

For MIMO in FR1, up to 32 CSI-RS antenna ports is supported, and in FR2, up to 8 CSI-RS antenna ports is supported. In next generation cellular standards (e.g., 6G), in addition to FR1 and FR2, new carrier frequency bands can be evaluated, e.g., FR4 (>52.6 GHz), terahertz (>100 GHz) and upper mid-band (10-15 GHz). The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW (e.g., the network 130) deployment/topology at these frequencies is also expected to be denser/distributed, for example, antenna ports distributed at multiple (non-co-located, hence geographically separated) TRPs within a cellular region can be the main scenario of interest, due to which the number of CSI-RS antenna ports for MIMO can be even larger (e.g., up to 256).

A (spatial or digital) precoding/beamforming can be used across these large number of antenna ports in order to achieve MIMO gains. Depending on the carrier frequency, and the feasibility of radio RF/hardware (HW)-related components, the (spatial) precoding/beamforming can be fully digital or hybrid analog-digital. In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across antenna ports is provided.

In next generation cellular standards (e.g. 6G), in addition to FR1 and FR2, new carrier frequency bands can be evaluated, e.g., FR4 (>52.6 GHz), terahertz (>100 GHz) and upper mid-band (10-15 GHz). The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (non-co-located, hence geographically separated) TRPs within a cellular region can be the main scenario of interest, due to which the number of CSI-RS antenna ports for MIMO can be even larger (e.g. up to 256).

Likewise, for a cellular system operating in low carrier frequency in general, a sub-1 GHz frequency range (e.g. less than 1 GHz) as an example, supporting large number of CSI-RS antenna ports (e.g. 32) or many antenna elements at a single location or remote radio head (RRH) or TRP is challenging due to a larger antenna form factor size needed taking into account carrier frequency wavelength than a system operating at a higher frequency such as 2 GHz or 4 GHz. At such low frequencies, the maximum number of CSI-RS antenna ports that can be co-located at a site (or RRH or TRP) can be limited, for example to 8. This limits the spectral efficiency of such systems. In particular, the multiuser MIMO (MU-MIMO) spatial multiplexing gains offered due to large number of CSI-RS antenna ports (such as 32) can't be achieved due to the antenna form factor limitation. One plausible way to operate a system with large number of CSI-RS antenna ports at low carrier frequency is to distribute the physical antenna ports to different panels/RRHs/TRPs, which can be non-collocated. The multiple sites or panels/RRHs/TRPs can still be connected to a single (common) base unit forming a single antenna system, hence the signal transmitted/received via multiple distributed RRHs/TRPs can still be processed at a centralized location.

As described herein, for low (FR1), high (FR2 and beyond), or mid (6-15 GHz) band, the NW topology/architecture is likely to be more and more distributed in future due to reasons explained herein (e.g. use cases, HW requirements, antenna form factors, mobility etc.). In this disclosure, such a distributed system is referred to as a distributed MIMO (D-MIMO) or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Due to distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs.

In one example, a TRP or RRH can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, a cell group.

FIG. 10 illustrates a diagram of example RAN configurations 1000 according to embodiments of the present disclosure. For example, RAN configurations 1000 can be implemented by the BS 102 of FIG. 1. This example is for illustration only and other embodiments can be used without departing from the scope of the present disclosure.

In an O-RAN, a TRP can be functionally equivalent to (hence can be replaced with) or is interchangeable with one of more of the following:
One RU or O-RU: a logical node that includes a subset of the eNB/gNB functions (e.g. as listed in clause 4.2 split option 7-2x)
More than one RUs or O-RUs
One or more than one RUs or O-RUs

Two examples are shown in FIG. 10.

The following are defined in [REF11 and REF12].

| | |
|---|---|
| O-CU | O-RAN Central Unit—a logical node hosting PDCP, RRC, SDAP and other control |
| | functions |
| O-DU | O-RAN Distributed Unit: a logical node hosting RLC/MAC/High-PHY layers based |
| | on a lower layer functional split. O-DU in addition hosts an M-Plane instance. |
| O-RU | O-RAN Radio Unit: a logical node hosting Low-PHY layer and RF processing based |
| | on a lower layer functional split. This is similar to 3GPP's “TRP” or “RRH” but |
| | more specific in including the Low-PHY layer (FFT/iFFT, PRACH extraction). O- |
| | RU in addition hosts M-Plane instance. |

A typical network up to 5G network (NW) can be described in terms of transmit-receive points (TRPs). For a first frequency range (FR1), i.e., <6 GHz, a TRP can comprise one or more antenna ports, and is fully-digital (i.e. each antenna port is driven by a dedicated baseband processing chain); and for a second frequency range 24.25-52.6 GHz (FR2), i.e., for mmWave frequencies, a TRP comprises one of more antenna panels (sub-arrays), each comprising one or two antenna ports that are controlled by analog phase shifters that result in an analog beam (pointing in certain spatial direction). An antenna port in FR1 can also be beamformed (aka virtualization); however, such a beamforming (BF) is generally static (non-adaptive, hence not requiring measurement and reporting). In FR2, due to large propagation loss at mmWave frequencies, each antenna panel requires dynamic frequent update of the analog BF, which is often based on (analog) beam measurement and reporting.

A communication between the 5G NW and a user is broadly based on: (A1) NW resources, and (A2) signaling components, where the former corresponds to spatial-domain, frequency-domain, and time-domain (SD, FD, TD) resources allocated to the user for the communication, and the latter corresponds to components that are signaled over the NW resources. The SD resources can be based on a single TRP (sTRP) or multiple TRPs (mTRP), where mTRP can be (B1) co-located at a site/location or (B2) non-co-located/distributed at multiple sites/locations, where the latter corresponds to a distributed SD resource, hence the corresponding communication hypothesis can be (C1) non-coherent joint transmission (NCJT) where a data stream (layer) is transmitted from one of the mTRPs, or (C2) coherent JT (CJT), where a data stream (layer) can be transmitted from multiple of the mTRPs. The FD resources can comprise a set of PRBs, and the TD resources can comprise one or multiple time slots (i.e., 1 slot=N_{sym} consecutive symbols).

The signaling components include signaling associated with (D1) measurement, (D2) channel state information (CSI) report, and (D3) DL reception or UL transmission.

For (D1), the user measures channel measurement RSs (CMRs) to estimate the channel condition between the sTRP/mTRP and the user. In case of sTRP, the user can measure a set comprising one or multiple DL measurement resources. For mTRP, the measurement resources can be (E1) one resource set comprising one group per TRP, or (E2) one resource set per TRP. The user can also measure the interference based on interference measurement RSs (IMRs). A CMR can correspond to an analog beam, and can be repeated in multiple symbols for determining user's analog beam.

For (D2), the user, based on the measurement, determines the CSI and reports it to the NW, where the CSI can be (F1) (analog) beam-related CSI, or (F2) (digital) non-beam-related CSI. For (F1), the user determines one or multiple pairs (indicator, metric), where the indicator indicates a CMR and the metric indicates a (beam) quality (e.g. reference signal received power (RSRP), signal-to-interference-plus-noise ratio (SINR)).

For (F2), a low-resolution (Type-I) CSI and a high-resolution (Type-II) CSI are supported. The Type-I CSI is based on L=1 DFT SD vector per layer, requires low feedback overhead and is expected to work reasonably well for single user (SU)-MIMO. For multiuser-(MU-)MIMO transmission, however, high-resolution Type II CSI capturing multiple dominant directions of the channel is essential in order to suppress inter-user interference. The Type-II CSI is based on a weighted linear combination L>1 SD DFT vectors where the weights correspond to coefficients. The FD DFT vectors were additionally introduced enhanced Type-II CSI to reduce the CSI feedback overhead by compressing channel coefficients in both SD and FD. A further enhanced Type-II port-selection (PS) CSI was specified to further reduce the CSI overhead by exploiting a reciprocity of angle-and-delay domain between uplink and downlink channels. Expecting NW performs pre-processing with beamformed CSI-RS to concentrate angle-and-delay domain components in few SD and FD basis directions, the user can be configured to select a subset of antenna ports (at a TRP) and one or two FD vectors. Additionally, a NCJT Type-I CSI was supported for up to two TRPs and multiple (sTRP or NCJT) hypotheses. Furthermore, the enhanced Type-II CSI is extended to support CJT Type-II CSI from mTRP and for high/medium user velocities exploiting time-domain correlation or Doppler-domain information, respectively.

A transmission configuration indication (TCI) framework is shared between (non-beam-related) CSI and beam management (BM). While the complexity of such a TCI framework is justified for CSI acquisition in FR1, it makes BM procedures less efficient in FR2. Furthermore, the BM procedures can be different for different channels due to their different target scenarios. Having different beam indication/update mechanisms increases the complexity, overhead, and latency of BM. Such drawbacks are especially troublesome for high mobility scenarios (such as highway and high-speed train). These drawbacks motivated a streamlined BM framework for beam-based operations and procedures that is common for data and control, and uplink (UL) and downlink (DL) channels. This framework is referred to as a unified TCI (uTCI) framework, firstly introduced for sTRP and now being enhanced for mTRP.

The uTCI framework supports signaling of a unified TCI state to a user, where the unified TCI state can be a DL-TCI, an UL-TCI or a joint TCI (J-TCI) state, where a DL-TCI state is applied for receiving DL channels/signals, an UL-TCI state is applied for transmitting UL channels/signals, and a J-TCI state is applied for both DL and UL channels/signals. The uTCI framework is designed to support DL receptions and UL transmissions (i) with a joint (common) beam indication for DL and UL by leveraging beam correspondence (reciprocity between DL and UL), and (ii) with separate beam indications for DL and UL, for example to mitigate maximum permissible exposure, where the beam direction of an UL transmission is different from the beam direction of a DL reception to avoid exposure of the human body to radiation.

The uTCI framework can support a beam-level mobility, known as inter-cell BM (ICBM). In ICBM, the user-dedicated channels can be configured to use a beam (i.e., TCI state) associated with a (non-serving) cell having a physical cell identity (PCI) that is different from the PCI of the serving cell. This allows fast beam-switch to a non-serving cell for user-dedicated channels at a lower layer without involving a higher layer and without incurring latency and overhead of handover.

The ICBM is being further enhanced to support a complete cell-switch triggered by lower layers, which is known as lower-layer triggered mobility (LTM). In LTM, the NW can acquire beam measurements, and UL timing information for target candidate cells before cell-switch. The lower layers of the NW decide when to perform a cell-switch, and send a medium access control channel element (MAC CE) containing a cell-switch command (CSC) that triggers the cell-switch from a source cell to a target cell. The CSC includes beam (i.e., TCI state) and UL timing information for the user to use on the target cell. After a beam application delay, the user and the NW communicates via the target cell.

NW energy saving (NES) is another advanced feature, wherein the NW can optimize energy usage by turning TRPs ON/OFF, thereby saving power. From a user's perspective, this is akin to dynamic SD resource update between transmissions. The CSI in the NES scenario can be based on multiple sub-configurations, each corresponding to different SD resource assignments, and dynamically (via DCI) triggering one or multiple of the sub-configurations for CSI reporting.

Full-duplex transmission and reception in the same NR channel BW or using non-contiguous intra-band carrier aggregation (CA) is a promising technology to enhance UL coverage, reduce latency and improve system capacity and to overcome limitations inherent to the use of de-facto mandated semi-static time division duplexing (TDD) UL-DL frame configurations in today's NR TDD deployments. Currently, 3GPP is studying benefits, feasibility and deployment scenarios for enabling NW-side full-duplex operation where simultaneous transmissions and receptions by the NW on the same time-domain symbol on the NR carrier can only occur in non-overlapping UL and DL subbands, e.g., subband full-duplex (SBFD) mode. In this first step of NR duplex evolution, users with support for NW-side SBFD operation still operate in half-duplex, i.e., the user can either transmit or receive on an SBFD symbol but not transmit and receive simultaneously. An SBFD UL subband can be located in the center or at the edge of the NR carrier in FR1 or FR2-1. For CA-based SBFD in FR2-1, one component carrier (CC) is allocated for UL transmissions whereas the remaining CCs are used for DL transmission.

NW-side self-interference cancellation (SIC) capability to enable SBFD can be realized through a combination of solutions. For example, the NW can use Tx/Rx antenna isolation on the antenna panel(s), beam steering, analog and/or digital pre-distortion, digital interference cancellation, and analog and/or digital filtering solutions. Note that passive Tx/Rx antenna isolation has been demonstrated to achieve in excess of 80 dB in FR1 with even higher isolation in FR2-1. For example, SBFD for the Local Area base station class characterized by small Tx power and reduced Rx sensitivity can already achieve a significant amount of SIC capability by relying on antenna isolation alone. Wide Area base stations characterized by much higher transmit power and higher Rx sensitivity may need to implement a more extensive set of solutions to support SBFD.

NW-side SBFD operation can be enabled transparently for typical NR users and has been shown feasible and providing gains. In this case, typical users are scheduled UL transmissions in the SBFD UL subband of the NR carrier on symbols configured as flexible by SIB1. More gains in the NR TDD cell supporting NW-side SBFD operation can be achieved in presence of SBFD-aware users, e.g., supporting resource allocation enhancements for PDSCH, PUSCH and PUCCH including handling of TCI states and BF, and CSI reporting enhancements to best exploit the link conditions on SBFD and non-SBFD slots/symbols on the serving cell.

As explained, the 5G NW can support several features, services, use cases, and deployment scenarios. It however also introduces too many different abstractions (for specification) of NW entities and involved signaling for components of these abstractions. For instance, the specification supports abstractions for single-cell, multi-cell, sTRP, mTRP, panel, antenna panel, antenna port, resource, resource set, and beam; and signaling for a complicated CSI framework based on components such as CSI resource setting (one or more CSI-RS resources sets, each with one or more CSI-RS/synchronization signal block (SSB) resources) and CSI report setting that links a CSI resource setting to a report quantity from a set of multiple supported report quantities, wherein a report quantity can correspond to beam report (i.e. an analog beam and a beam quality) or a non-beam report (i.e. rank indicator (RI), precoding matrix indicator (PMI), channel quality indicator (CQI), CQI report interval (CRI)). In addition, for PMI, too many different codebooks are supported. Due to these reasons, deployment of the 5G NW is challenging in reality. A direct scaling/extension/reuse of these typical up to 5G solutions for 6G will add to the complexity, which is undesired in real NW deployments.

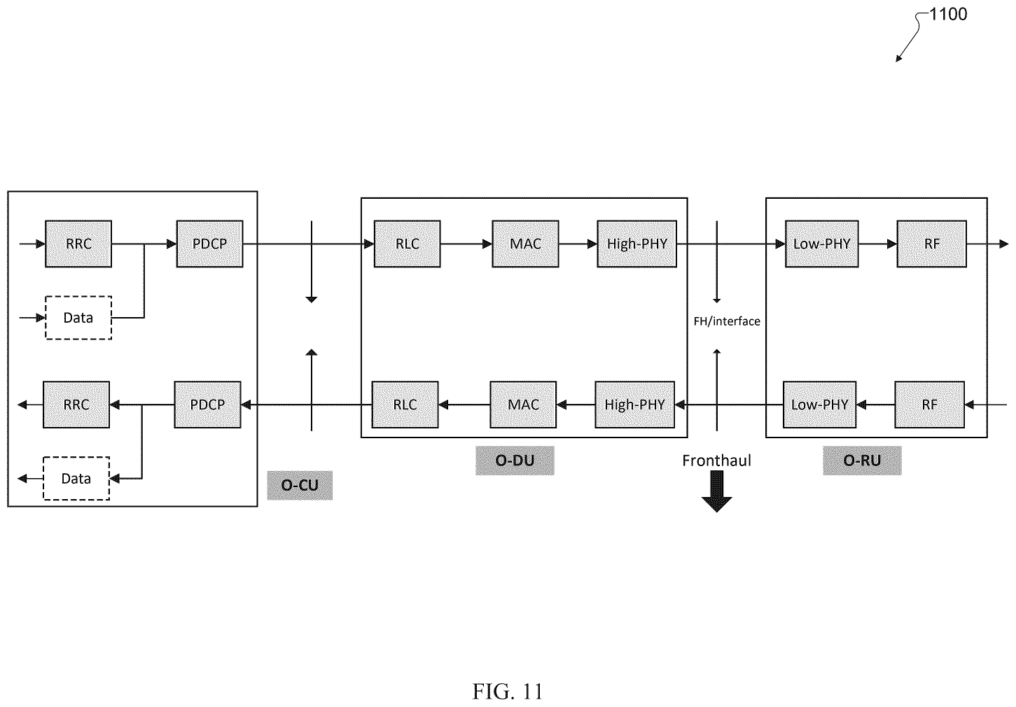

FIG. 11 illustrates a diagram of example functional split points/options 1100 according to embodiments of the present disclosure. For example, functional split points/options 1100 may be implemented by the BS 102 of FIG. 1. This example is for illustration only and other embodiments can be used without departing from the scope of the present disclosure.

In next-gen MIMO systems (e.g. 6G), at least two aspects need to be evaluated.
(A) 3GPP PHY specification: The significance of a single NW entity, namely PG (as a collection of ports) in terms of port-common channel properties. This is analogous to the 5G QCL (or TCI state), coherency assumption (e.g. FC, PC, NC).
(B) NW architecture as perceived in O-RAN: The functionality split among O-RAN entities for DL and UL operations, such as O-RU, O-DU, and O-CU (as described herein). An example is shown in FIG. 11. In particular, the PHY functionality split between O-DU and O-RU includes at least the following aspects.
   (B1) PHY processing:
      bit-level processing,
      symbol-level processing
   (B2) Scheduling (residing in MAC): SU-MIMO/MU-MIMO scheduling across different O-RUs or/and allocated frequency-domain resources (e.g. PRBs, precoding resource block groups (PRGs), subbands (SBs))
      Utilizing UCI carrying CSI
      If DL/UL reciprocity is feasible, also utilizing SRS-based channel measurement
   (B3) Precoder calculation at a gNB (e.g., the BS 102) (NW side) for DL-SCH transmission:
      For SU-MIMO, precoder can simply follow the PMI (calculated assuming SU-MIMO hypothesis) reported by the UE, or, if DL/UL reciprocity is feasible, be calculated from the eigenvector(s) of the measured DL channels.
      For MU-MIMO, precoder needs to be calculated based on additional orthogonalization (e.g. zero-forcing beamforming (ZFBF), signal-to-leakage-and-noise-ratio (SLNR)) among PMIs, or, if DL/UL reciprocity is feasible, the eigenvectors of the measured channels of the co-scheduled UEs

The first (A) can be achieved by removing/merging duplicate/redundant abstractions, and simplifying signaling for components of the abstractions. One such framework, namely dynamic MIMO, is provided in this disclosure, wherein abstractions such as CSI-RS resource, CSI-RS resource set, port, beam, TRP, panel etc. can be clubbed into one basic entity, namely antenna/port group (PG or O-RU (or RU)), and essential features of PGs are specified. A few essential features discussed include dynamic PG or O-RU (or RU) selection and long-term stats and assumptions across PGs, e.g., quasi co-location (QCL) and coherency relationships across PGs. The provided framework can also facilitate fast and accurate CSI acquisition, where the CSI can be beam-related (e.g. beam indicator, beam metric), non-beam-related (e.g. RI/PMI/CQI), or both. Additionally, the concept of a cell is replaced with PGs that are distributed through the NW. The mobility can be handled via the PG or O-RU (or RU) selection/update (from one set of PGs to another set of PGs).

A few relevant (more-probable) candidates discussed in the O-RAN Alliance (depicted in FIG. 11) are shown in Table 0.

TABLE 0
(both DL and UL)

| | | | | | | | |
|---|---|---|---|---|---|---|---|
| | | | High- | Low- | | | |
| PDCP | RLC | MAC | PHY | PHY | RF | HLS | LLS |

| | | | | | |
|---|---|---|---|---|---|
| O-RAN¹ | O-CU: | O-DU: RLC, MAC, | O-RU: Low- | Y | symbol- |
| (Opt7-2x) | PDCP | High-PHY | PHY, RF | | level |
| | | | | | PHY |
| Opt7-3 | O-CU: | O-DU: RLC, MAC, | O-RU: Low- | Y | bit-level |
| | PDCP | High-PHY | PHY, RF | | PHY |

| | | | | |
|---|---|---|---|---|
| Opt8 | DU: RLC, MAC, PHY | RU: | Y | CPRI |

RF

O-RANI: [REF 12]
Cat-A, Cat-B
UL: Cat-C

The 5G NR MIMO inherits a number of unnecessary hierarchical specification entities from 4G LTE. In relation to multi-antenna (MIMO), such entities include:
Pointless “middlemen” abstractions such as resource and resource-set entities for RS
Obsolete implementation-based abstractions, e.g., for panel, multi-panel, “TRP”, FR1 port vs FR2 beam/resource, “cell”

In next-generation systems, (e.g. 6G), the MIMO framework can be simplified/streamlined in order to (i) support both up to 5G and new frequency bands (e.g. FR3), (ii) enable new features/services (such as AI/ML-based learning, evolved duplexing, and energy saving), (iii) make it implementation friendly, and (iv) have a future-proof and easily upgradable system.

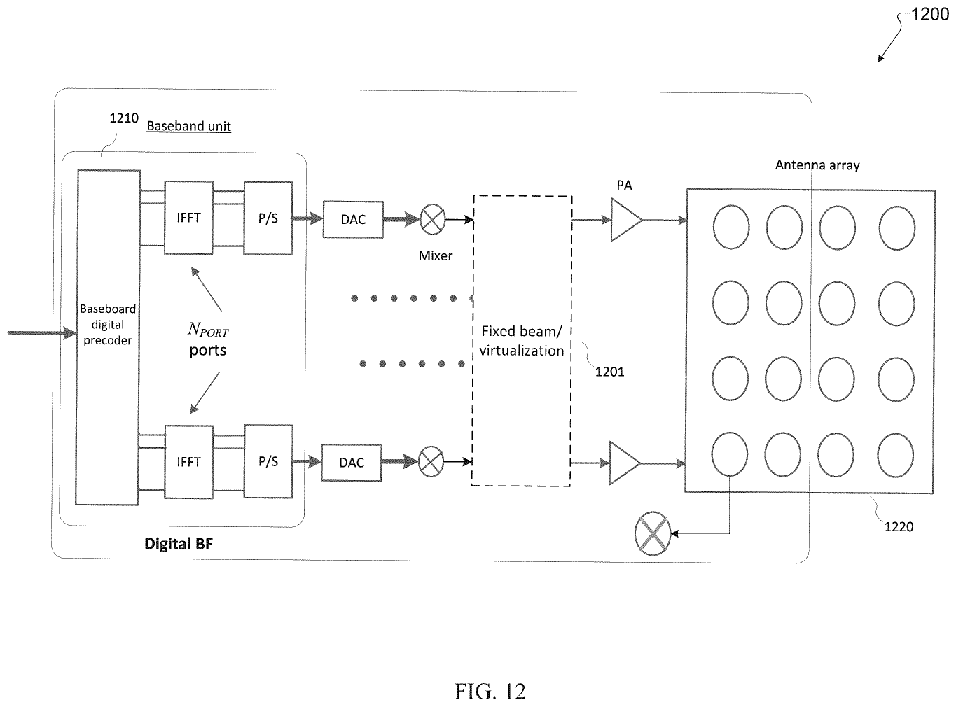

FIG. 12 illustrates an example of a fully digital transmitter structure 1200 for beamforming according to embodiments of the present disclosure. For example, fully digital transmitter structure 1200 can be implemented in the BS 102 of FIG. 2. This example is for illustration only and other embodiments can be used without departing from the scope of the present disclosure.

The fully digital transmitter structure 1200 includes a digital beamformer 1210, a fixed beam/virtualization 1201, and antenna array angles 1220.

A 5G NW can be built upon a spatial resource entity, say X. For a first frequency range (FR1), i.e., <6 GHz, the spatial entity X comprises one or more antenna ports that are fully-digital (i.e. each antenna port is driven by a dedicated baseband processing chain), as shown in FIG. 12; and for a second frequency range 24.25-52.6 GHz (FR2), i.e., for mmWave frequencies, the entity X comprises one or more antenna panels (sub-arrays), each comprising one (or two) antenna ports that is (are) controlled by analog phase shifters that result in an analog beam (pointing in certain spatial direction), as shown in FIG. 5. An antenna port in FR1 can also be beam-formed (aka virtualization); however, such a beamforming (BF) is generally static (non-adaptive, hence does not requiring measurement and reporting). In FR2, due to large propagation loss at mmWave frequencies, each antenna panel requires dynamic frequent update of the analog BF, which is often based on (analog) beam measurement and reporting.

Thus, embodiments of the present disclosure recognize that the main difference between a FR1 port and a FR2 panel is that the beam/virtualization (i.e. port assignment) is fixed in the former, and it requires (a) measurement and reporting from UE and (b) a beam indication from the NW (TCI state with QCL-TypeD). A unified framework in which a port in FR1 and a panel in FR2 can be abstracted based on a unified, band-agnostic spatial entity, e.g. port or port group (PG), and associated QCL and coherency properties across ports or PGs (intra-/inter PG). For instance,
Port: a FR1 port and a FR2 beam/source
Port group (PG): TRP, resource, resource set, panel, cell

While the O-RAN Alliance is intended for 5G NR, it is expected that its framework will continue, or at most refined, for 6G. The O-RAN Alliance specifies 3 levels of functional splits—namely CU, DU, and RU—to facilitate multi-vendor inter-operability within a NW. The manner in which PHY-layer functions are split between DU and RU(s) imposes serious impact on the feasibility, performance, and complexity of different MMO schemes—mainly due to the latency and quantization loss incurred by the O-RAN-standardized RU-DU interface.

Instead of reusing the 4G/5G abstraction of CSI-RS resource or resource set, the terms “port” as a spatial-domain resource unit and “port group” (PG) as a collection of ports sharing a same set of channel properties are used irrespective of the frequency band. In this sense, a “port” can be associated with a digital port in FR1 or an analog beam in FR2 (thereby abandoning the 5G association between an analog beam and a CSI-RS resource for FR2).

The present disclosure relates to next generation communication systems (e.g. adv. 5G and 6G) based on a MIMO framework as described herein. This disclosure, in particular provides measurement and reporting to facilitate efficient UL MIMO operations, and following are aspects of this disclosure:
Reporting of L>1 SD vectors to facilitate UL operations such as reducing number of candidate UL ports or SD vectors for UL transmission
Details on measurement and reporting (e.g. time domain behavior, FD granularity etc.)
UCI design (e.g. standalone vs non-standalone, one-part vs two-part UCI)

In the following, for brevity, both FDD and TDD are regarded as the duplex method for both DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure covers several components which can be used in conjunction or in combination with one another, or can operate as standalone schemes.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” or bandwidth part (BWP) can also be used.

In terms of ULE configuration, a UE (e.g., the UE 116) can be configured with at least one CSI reporting band. This configuration can be semi-static (via higher-layer signaling or RRC) or dynamic (via MAC CE or L1 DL control signaling). When configured with multiple (N) CSI reporting bands (e.g. via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for the Mₙ subbands within the CSI reporting band. A CSI parameter is configured with “subband” for the CSI reporting band with Mₙ subbands when one CSI parameter is reported for each of the Mₙ subbands within the CSI reporting band.

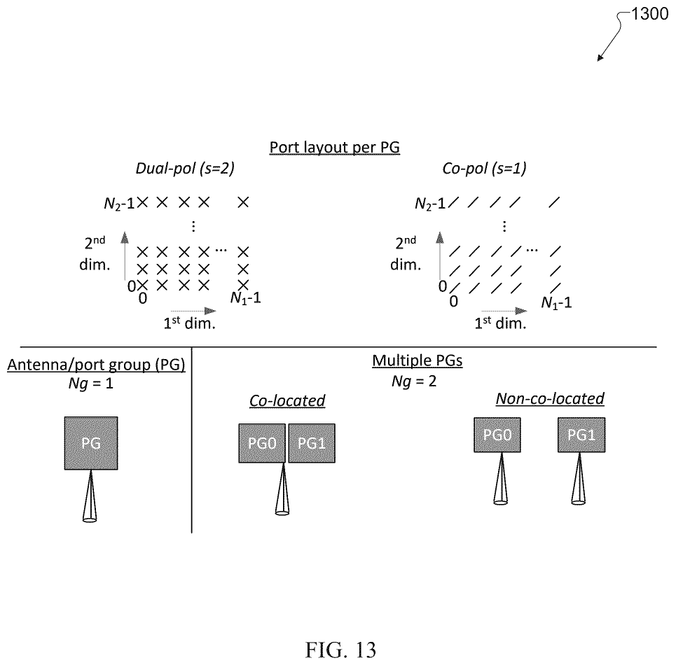

FIG. 13 illustrates a diagram of an example antenna port layout 1300 according to embodiments of the present disclosure. For example, antenna port layout 1300 can be implemented in the wireless network 100 of FIG. 1. This example is for illustration only and can be used without departing from the scope of the present disclosure.

In the following, N₁ and N₂ are the number of antenna ports with the same polarization in the first and second dimensions, respectively. For 2D antenna port layouts, N₁>1, N₂>1, and for 1D antenna port layouts either N₁>1 and N₂=1 or N₂>1 and N₁=1. In the rest of the disclosure, 1D antenna port layouts with N₁>1 and N₂=1 is provided. The disclosure, however, is applicable to the other 1D port layouts with N₂>1 and N₁=1. Also, in the rest of the disclosure, N₁≥N₂. The disclosure, however, is applicable to the case when N₁<N₂, and the embodiments for N₁>N₂ apply to the case N₁<N₂ by swapping/switching (N₁, N₂) with (N₂, N₁). For a single-polarized (or co-polarized) antenna port layout, the total number of antenna ports is P_{CSIRS}=N₁N₂. And, for a dual-polarized antenna port layout, the total number of antenna ports is P_{CSIRS}=2N₁N₂. An illustration is shown in FIG. 13 where “X” represents two antenna polarizations (dual-pol, s=2) and “/” represents one antenna polarization (co-pol, s=1). In this disclosure, the term “polarization” refers to a group of antenna ports with the same polarization. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g. X=3000, then antenna ports are 3000, 3001, 3002, . . . ). Unless stated otherwise, dual-polarized antenna layouts are expected in this disclosure. The embodiments (and examples) in this disclosure however are general and are applicable to single-polarized antenna layouts as well.

Let s denotes the number of antenna polarizations (or groups of antenna ports with the same polarization). Then, for co-polarized antenna ports, s=1, and for dual- or cross (X)-polarized antenna ports s=2. So, the total number of antenna ports P_{CSIRS}=sN₁N₂.

Let N_{g} be a number of antenna/port groups (PGs). When there are multiple antenna/port groups (N_{g}>1), each group (g∈{1, . . . , N_{y}}) comprises N_{1,g} and N_{2,g} ports in two dimensions. This is illustrated in FIG. 13. Note that the antenna port layouts may be the same (N_{1,g}=N₁ and N_{2,g}=N₂) in different antenna/port groups, or they can be different across antenna/port groups. For group g, the number of antenna ports is P_{CSIRS,g}=N_{1,g}N_{2,g} or 2N_{1,g}N_{2,g} (for co-polarized or dual-polarized respectively), i.e., P_{CSIRS,g}=s_{g}N_{1,g}N_{2,g} where s_{g}=1 or 2.

In one example, an antenna/port group corresponds to an antenna panel. In one example, an antenna/port group corresponds to a TRP. In one example, an antenna/port group corresponds to an RRH. In one example, an antenna/port group corresponds to CSI-RS antenna ports of a NZP CSI-RS resource. In one example, an antenna/port group corresponds to a subset of CSI-RS antenna ports of a NZP CSI-RS resource (comprising multiple antenna/port groups). In one example, an antenna/port group corresponds to CSI-RS antenna ports of multiple NZP CSI-RS resources (e.g. comprising a CSI-RS resource set).

In one example, an antenna/port group corresponds to a reconfigurable intelligent surface (RIS) in which the antenna/port group can be (re-)configured more dynamically (e.g. via MAC CE or/and DCI). For example, the number of antenna ports associated with the antenna/port group can be changed dynamically.

In one example, the antenna architecture of the MIMO system is structured. For example, the antenna structure at each PG or O-RU (or RU) is dual-polarized (single or multi-panel as shown in FIG. 13. The antenna structure at each PG or O-RU (or RU) can be the same. Or, the antenna structure at an PG or O-RU (or RU) can be different from another PG or O-RU (or RU). Likewise, the number of ports at each PG (OR O-RU OR RU) can be the same. Or, the number of ports at one PG (OR O-RU OR RU) can be different from another PG (OR O-RU OR RU).

In another example, the antenna architecture of the MIMO system is unstructured. For example, the antenna structure at one PG (OR O-RU OR RU) can be different from another PG (OR O-RU OR RU).

A structured antenna architecture is provided in/for the rest of the disclosure. For simplicity, each PG (OR O-RU OR RU) is equivalent to a panel (cf. FIG. 13), although, an PG (OR O-RU OR RU) can have multiple panels in practice. The disclosure however is not restrictive to a single panel assumption at each PG (OR O-RU OR RU), and can easily be extended (covers) the case when an PG (OR O-RU OR RU) has multiple antenna panels.

In one embodiment, an PG (OR O-RU OR RU) constitutes (or corresponds to or is equivalent to) at least one of the following:
In one example, an PG OR O-RU (OR RU) corresponds to a TRP.
In one example, an PG or O-RU (or RU) corresponds to a CSI-RS resource. A UE is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained in this disclosure.
In one example, an PG or O-RU (or RU) corresponds to a CSI-RS resource group, where a group comprises one or multiple NZP CSI-RS resources. A UE is configured with K≥N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained in this disclosure. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.
In one example, an PG or O-RU (or RU) corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an PG or O-RU (or RU). The information about the subsets of ports or grouping of ports can be provided together with the CSI-RS resource setting/configuration, or with the CSI reporting setting/configuration, or with the CSI-RS resource configuration.
In one example, an PG or O-RU (or RU) corresponds to one or more examples described herein depending on a configuration. For example, this configuration can be explicit via a parameter (e.g. an RRC parameter). Or, it can be implicit.
   In one example, when implicit, it could be based on the value of K. For example, when K>1 CSI-RS resources, an PG or O-RU (or RU) corresponds to one or more examples described herein, and when K=1 CSI-RS resource, an PG or O-RU (or RU) corresponds to one or more examples described herein.
   In another example, the configuration could be based on the configured codebook. For example, an PG or O-RU (or RU) corresponds to a CSI-RS resource (according to one or more examples described herein) or resource group (according to one or more examples described herein) when the codebook corresponds to a decoupled codebook (modular or separate codebook for each PG or O-RU (or RU)), and an PG or O-RU (or RU) corresponds to a subset (or a group) of CSI-RS ports (according to one or more exampled described herein) when codebook corresponds to a coupled (joint or coherent) codebook (one joint codebook across PGs).

In one example, when PG or O-RU (or RU) maps (or corresponds to) a CSI-RS resource or resource group (according to one or more examples described herein), and a UE can select a subset of PGs (resources or resource groups) and report the CSI for the selected PGs (resources or resource groups), the selected PGs can be reported via an indicator. For example, the indicator can be a CRI or a PMI (component) or a new indicator.

In one example, when PG or O-RU (or RU) maps (or corresponds to) a CSI-RS port group (according to one or more examples described herein), and a UE can select a subset of PGs (port groups) and report the CSI for the selected PGs (port groups), the selected PGs can be reported via an indicator. For example, the indicator can be a CRI or a PMI (component) or a new indicator.

In one example, when multiple (K>1) CSI-RS resources are configured for N_{g} PGs (according to one or more examples described herein), a decoupled (modular) codebook is used/configured, and when a single (K=1) CSI-RS resource for N_{g} PGs (according to one or more examples described herein), a joint codebook is used/configured.

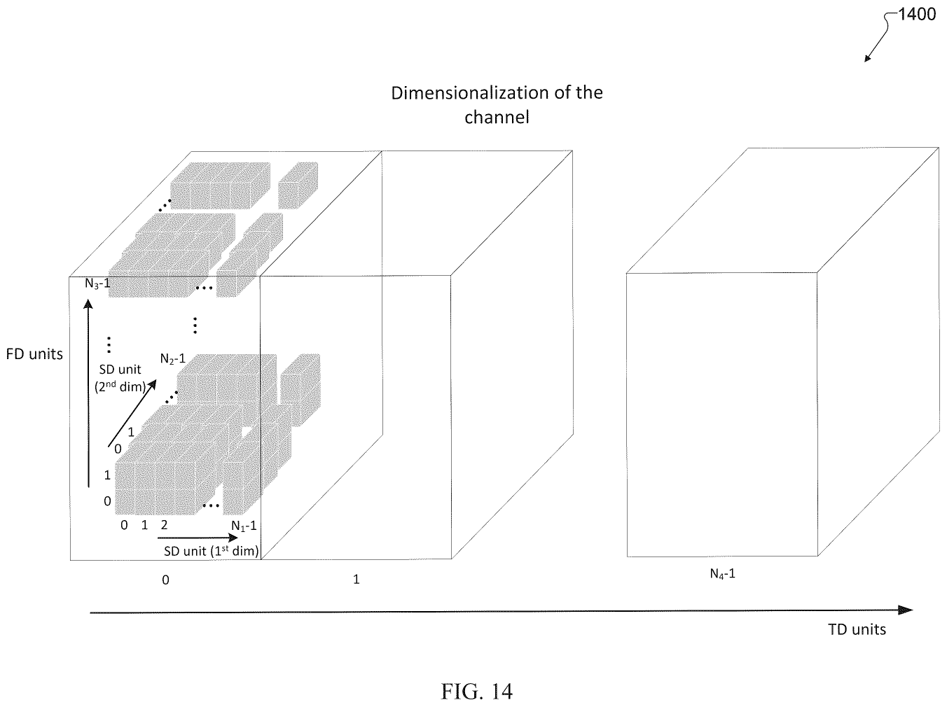

FIG. 14 illustrates a timeline 1400 of example SD units and FD units according to embodiments of the present disclosure. For example, timeline 1400 can be followed by any of the UEs 111-116 of FIG. 1, such as the UE 116. This example is for illustration only and other embodiments can be used without departing from the scope of the present disclosure.

In one embodiment, a UE is configured (e.g. via a higher layer CSI configuration information) with a CSI report, where the CSI report is based on a channel measurement (and interference measurement) and a codebook. When the CSI report is configured to be aperiodic, it is reported when triggered via a DCI field (e.g. a CSI request field) in a DCI.

The channel measurement can be based on K>1 channel measurement resources (CMRs) that are transmitted from a plurality of spatial-domain (SD) units (e.g. a SD unit=a CSI-RS antenna port), and are measured via a plurality of frequency-domain (FD) units (e.g. a FD unit=one or more PRBs/SBs) and via either a time-domain (TD) unit or a plurality of TD units (e.g. a TD unit=one or more time slots). In one example, a CMR can be a NZP-CSI-RS resource.

The CSI report can be associated with the plurality of FD units and the plurality of TD units associated with the channel measurement. Alternatively, the CSI report can be associated with a second set of FD units (different from the plurality of FD units associated with the channel measurement) or/and a second set of TD units (different from the plurality of TD units associated with the channel measurement). In this later case, the UE, based on the channel measurement, can perform prediction (interpolation or extrapolation) in the second set of FD units or/and the second set of TD units associated with the CSI report.

An illustration of the SD units (in 1^{st} and 2^{nd} antenna dimensions), FD units, and, and TD units is shown in FIG. 14.
The first dimension is associated with the 1st antenna port dimension and comprises N₁ units,
The second dimension is associated with the 2nd antenna port dimension and comprises N₂ units,
The third dimension is associated with the frequency dimension and comprises N₃ units, and
The fourth dimension is associated with the time/Doppler dimension and comprises N₄ units.

Alternatively, the SD units, FD units, and, and TD units are as follows.
The first dimension is associated with the antenna port dimension and comprises P_{CSIRS} units,
The second dimension is associated with the frequency dimension and comprises N₃ units, and
The third dimension is associated with the time/Doppler dimension and comprises N₄ units.

The plurality of SD units can be associated with antenna ports (e.g. co-located at one site or distributed across multiple sites) comprising one or multiple antenna/port groups (i.e., N_{g}≥1), and dimensionalizes the spatial-domain profile of the channel measurement.

When K=1, there is one CMR comprising P_{CSIRS} CSI-RS antenna ports.
When N_{g}=1, there is one PG comprising P_{CSIRS} ports, and the CSI report is based on the channel measurement from the one PG.
When N_{g}>1, there are multiple PGs, and the CSI report is based on the channel measurement from/across the multiple PGs.

When K>1, there are multiple CMRs, and the CSI report is based on the channel measurement across the multiple CMRs. In one example, a CMR corresponds to an PG (one-to-one mapping). In one example, multiple CMRs can correspond to an PG (many-to-one mapping).

In one example, when the P_{CSIRS} antenna ports are co-located at one site, N_{g}=1. In one example, when the P_{CSIRS} antenna ports are distributed (non-co-located) across multiple sites, N_{g}>1.

In one example, when the P_{CSIRS} antenna ports are co-located at one site and within a single antenna panel, N_{g}=1. In one example, when the P_{CSIRS} antenna ports are distributed across multiple antenna panels (can be co-located or non-co-located), N_{g}>1.

The value of N_{g} can be configured, e.g. via higher layer RRC parameter. Or, it can be indicated via a MAC CE. Or, it can be provided via a DCI field.

Likewise, the value of K can be configured, e.g. via higher layer RRC parameter. Or, it can be indicated via a MAC CE. Or, it can be provided via a DCI field.

In one example, K=N_{g}=X. The value of X can be configured, e.g. via higher layer RRC parameter. Or, it can be indicated via a MAC CE. Or, it can be provided via a DCI field.

In one example, the value of K is determined based on the value of N_{g}. In one example, the value of N_{g} is determined based on the value of K.

The plurality of FD units can be associated with a frequency domain allocation of resources (e.g. one or multiple CSI reporting bands, each comprising multiple PRBs) and dimensionalizes the frequency (or delay)-domain profile of the channel measurement.

The plurality of TD units can be associated with a time domain allocation of resources (e.g. one or multiple CSI reporting windows, each comprising multiple time slots) and dimensionalizes the time (or Doppler)-domain profile of the channel measurement.

In one example, the number of antenna ports across K CSI-RS resources is the same. For example, each of the K CSI-RS resources can be associated with 2N₁N₂ antenna ports. In this case, the total number of antenna ports is P_{CSIRS,tot}=2KN₁N₂.

In one example, the number of antenna ports across K CSI-RS resources can be the same or different. For example, each of the K CSI-RS resources can be associated with 2N_{1,r}N_{2,r} antenna ports. In this case, the total number of antenna ports is

$${P}_{CSIRS , tot} = {\sum }_{r = 1}^{K} 2 {N}_{1 , r} {N}_{2 , r} .$$

In port numbering scheme 1, the CSI-RS ports are numbered according to the order of (polarization p, NZP CSI-RS resource r) as CSI-RS ports of (p=0, r=1) followed by CSI-RS ports of (p=1,r=1), followed by CSI-RS ports of (p=0,r=2), followed by CSI-RS ports of (p=1, r=2), . . . , followed by CSI-RS ports of (p=0, r=N) followed by CSI-RS ports of (p=1,r=N).

In port numbering scheme 2, the CSI-RS ports are numbered according to the order of (polarization p, NZP CSI-RS resource r) as
CSI-RS ports of (p=0, r=1) followed by CSI-RS ports of (p=0, r=1), . . . , followed by CSI-RS ports of (p=0, r=N), and
then CSI-RS ports of (p=1, r=1) followed by CSI-RS ports of (p=1, r=1), . . . , followed by CSI-RS ports of (p=1, r=N).

In one example, an PG corresponds to an antenna, an antenna group (multiple antennae), an antenna port, an antenna port group (multiple ports), a CSI-RS resource, a CSI-RS resource set, a group of CSI-RS resources, a panel, an RRH, a Tx-Rx entity, a (analog) beam, a (analog) beam group, a cell, a cell group.

In one example, PGs can have a uniform (the same/common) structure. For example, they can have the same number of ports (P_{CSIRS,r}=P_{CSIRS}) or the same antenna port layout (N_{1,r}, N_{2,r})=(N₁, N₂). In one example, PGs can have non-uniform (or different) structure. For example, they can have the same or different number of ports (P_{CSIRS,r}_{₁}=P_{CSIRS,r}_{₂} or P_{CSIRS,r}_{₁}≠P_{CSIRS,r}_{₂}) or the same antenna port layout, i.e., (N_{1,r}_{₁}, N_{2,r}_{₁})=(N_{1,r}_{₂}, N_{2,r}_{₂}) or (N_{1,r}_{₁}, N_{2,r}_{₁}) #(N_{1,r}_{₂}, N_{2,r}_{₂}).

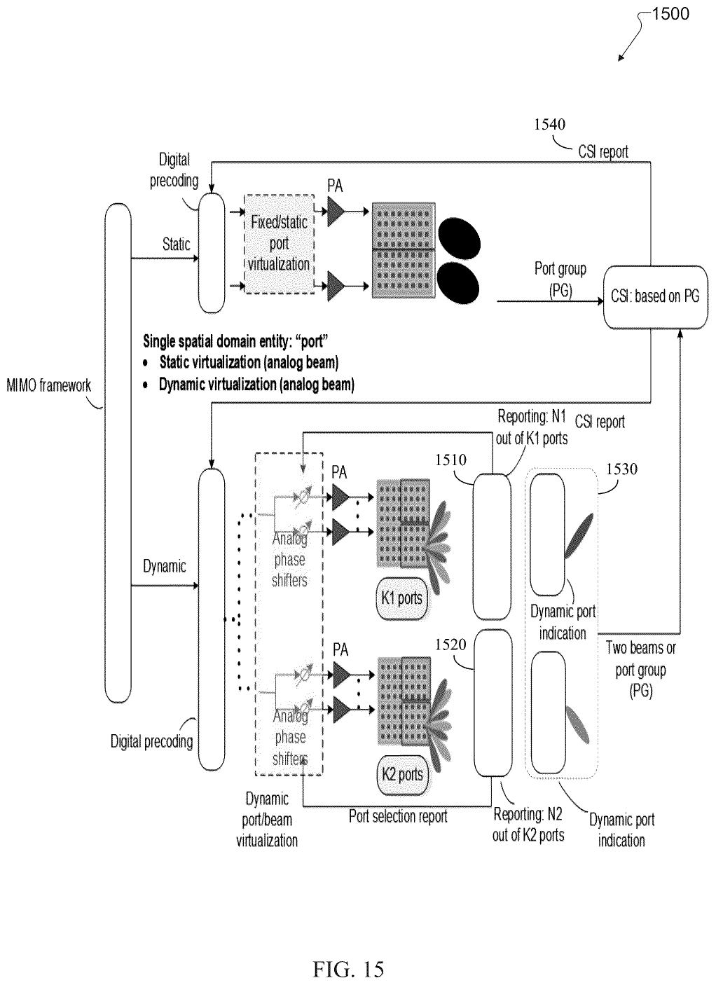

FIG. 15 illustrates an example PG 1500 according to embodiments of the present disclosure. For example, PG 1500 can be implemented in the BS 102 of FIG. 1. This example is for illustration only and other embodiments can be used without departing from the scope of the present disclosure.

For the purpose of DL CSI acquisition, when necessary, a port group (PG) can be defined as a collection of N_{b}≥1 ports sharing a commonly configured set of properties (analogous to CSI-RS resource in 5G NR). This is instrumental in CSI reporting utilized for mTRP or multiple O-RUs (especially CJT) or virtual sectorization where a TRP or a O-RU or a virtual sector corresponds to a PG. Three key components of the framework are shown in FIG. 15.
C1: measurement and reporting 1510 and 1520 to facilitate port selection/indication,
C2: dynamic indication 1530 of N port(s) out of K ports, and
C3: CSI reporting 1540 to enable digital precoding across a UE-recommended port group (PG).

In FR2 (i.e. in case of dynamic virtualization via analog beam), C1-C3 are utilized, and in FR1/FR3 (i.e., in case of fixed virtualization), only C3 is utilized. In the following, a PG is defined for FR1/FR3 (fixed virtualization case), not for FR2. In one example, PG is defined regardless of frequency band. An example FR1-FR3 are shown in Table 2.

TABLE 2

| Frequency range | Band |
|---|---|
| FR1 | Low band (<1 GHz) |
| FR1/FR3 | Lower mid band (1~7 GHz) |
| FR3 | Upper mid band (7~24) |
| FR2 | mmWave (>24 GHz) |

In one embodiment, a UE is configured with a CSI report (e.g. trigger state or a CSI report setting via higher layer IE CSI-AperiodicTriggerState or CSI-ReportConfig) based on a port-based/PG-based framework, wherein the CSI report is based on a measurement configuration (e.g. CSI-ResourceConfig or CSI-MeasurementConfig or CSI-PGConfig or CSI-PortConfig).

The measurement configuration includes a configuration for channel measurement, which can be according to one of the following examples.
In one example, the channel measurement corresponds to measuring P_{CSIRS} CSI-RS ports.
In one example, the channel measurement corresponds to measuring N_{g}≥1 PGs, where a PG g=1 . . . , N_{g} includes P_{CSIRS,r} CSI-RS ports.
In one example, the channel measurement corresponds to measuring the Q_{CSIRS} ports or M_{g} PGs indicated dynamically (E.g. via DCI or/and MAC CE), where the Q_{CSIRS} ports or M_{g} PGs respectively are from the configured the P_{CSIRS} ports or N_{g} PGs. The dynamic indication can facilitate turning ports or PGs ON/OFF (e.g. for energy saving purpose).

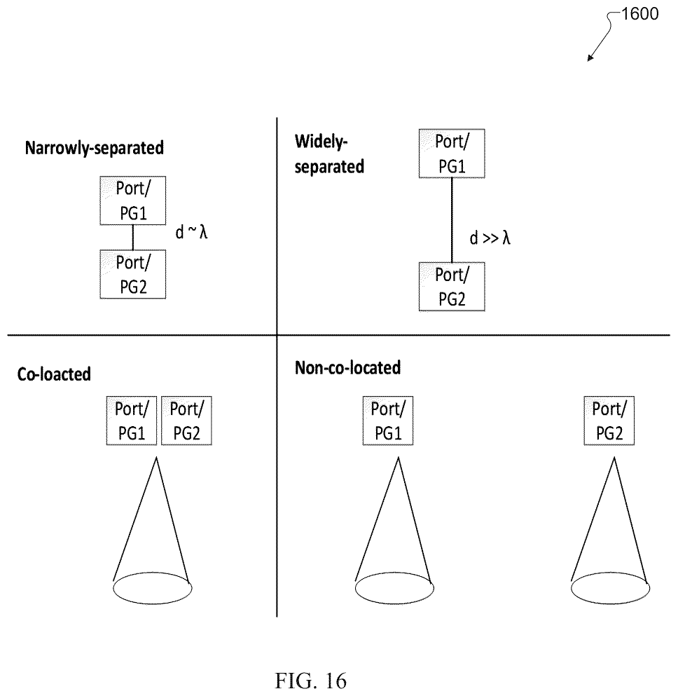

FIG. 16 illustrates examples of narrow/wide and co-located/non-co-located ports/PGs 1600 according to embodiments of the present disclosure. For example, narrow/wide and co-located/non-co-located ports/PGs 1600 can be implemented in the BS 103 of FIG. 1. This example is for illustration only and other embodiments can be used without departing from the scope of the present disclosure.

As shown in FIG. 16, the ports/PGs can be narrowly-spaced or widely-spaced with compared with the wavelength λ of the (center) carrier of the frequency band associated with the CSI report. Or, the ports/PGs can be col-located (at physical location) or non-co-located (at different physical locations).

The measurement configuration can also include a configuration for interference measurement.
In one example, the interference measurement corresponds to measuring I_{IMR} CSI-IMR ports. In one example, I_{IMR}=P_{CSIRS}. In one example, I_{IMR}=1.
In one example, the interference measurement corresponds to measuring I_{g}≥1 PGs, where a PG r=1 . . . , I_{g} includes I_{IMR,r} CSI-IMR ports. In one example, I_{g}=N_{g}. In one example, I_{g}=1. In one example, I_{IMR,r}=P_{CSIRS,r}. In one example, I_{IMR,r}=1.

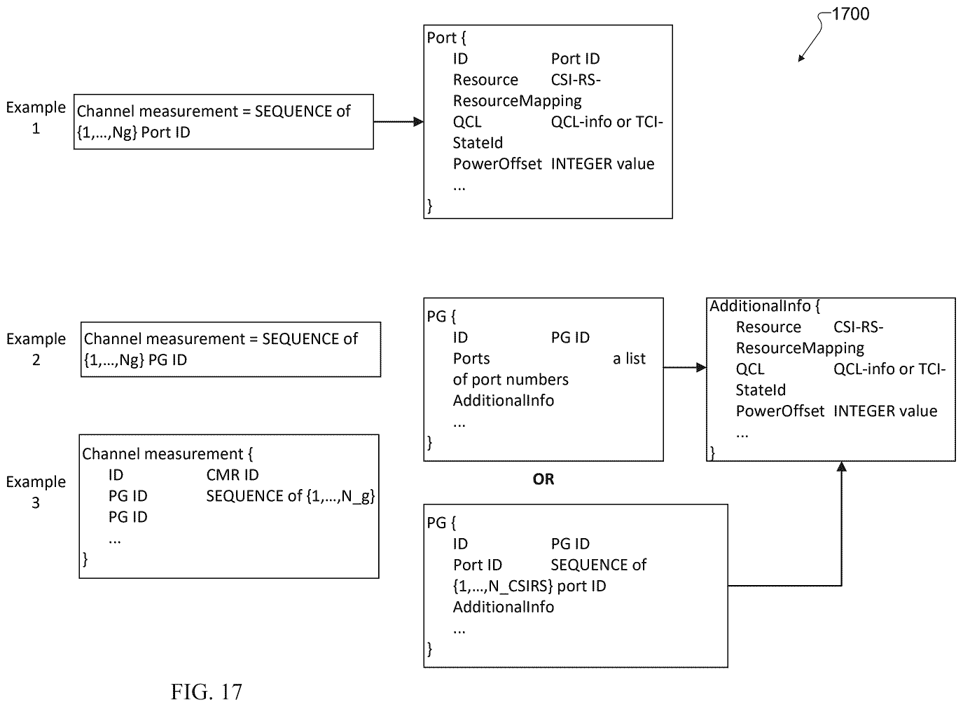

FIG. 17 illustrates examples of channel measurement configurations 1700 according to embodiments of the present disclosure. For example, channel measurement configurations 1700 can be configured by the BS 102 of FIG. 2. This example is for illustration only and other embodiments can be used without departing from the scope of the present disclosure.

In one example, a configuration for channel measurement includes at least one of the following:
In one example, a configuration for channel measurement includes a list (or sequence) of port IDs, where a port ID indicates an information (e.g. IE) about a port for measurement. Example 1 in FIG. 17 is an example.
In one example, a configuration for channel measurement includes an ID of a PG (e.g. PG ID) or a sequence of N_{g}≥1 IDs (e.g. each is a PG ID). Example 2 and 3 in FIG. 17 are two examples.
In one example, a configuration for channel measurement includes a list of port numbers (e.g. for CSI-RS, port numbers are from {3000, 3001, 3002, . . . }).

In one example, the UE receives a trigger message (e.g. which indicates a CSI-TriggerState) for aperiodic (AP) reporting of the CSI report. In one example, the trigger message is received via a DCI (e.g. CSI request field in an UL-related DCI or a CSI request field in a DL-related DCI or a CSI request field in a dedicated or special purpose DCI that is different from DL-related DCI or UL-related DCI). Here, DCI-related DCI corresponds to a DCI (format) that allocates DL PDSCH assignment, and UL-related DCI corresponds to a DCI (format) that grants UL PUSCH transmission.

In one example, the UE initiates/triggers the measurement/reporting by transmitting a message/request to the NW. The message/request acts as a trigger (e.g. which indicates a CSI-TriggerState) for the AP reporting of the CSI report. In one example, the message/request is via a layer 1 signaling such as scheduling request (SR) or UCI. In this example, higher layer RRC (or/and MAC CE) is used to configure (and activate) one or more than one AP CSI trigger states, and SR/UCI with the message/request acts as a trigger (without any indication from NW). The UL resource allocation (RA) for CSI report can be pre-configured (CG PUSCH), or granted after the UE-initiated trigger/request is received.

In one example, the UE initiates/triggers the measurement/reporting by transmitting a message/request to the NW. The message/request acts as a trigger (e.g. which indicates a CSI-TriggerState) for the AP reporting of the CSI report. The UE then receives an ACK (e.g. 1-bit in DCI), and then performs measurement and reporting of the CSI report. In one example, the message/request is via a layer 1 signaling such as scheduling request (SR) or UCI. In this example, higher layer RRC (or/and MAC CE) is used to configure (and activate) one or more than one AP CSI trigger states, and SR/UCI with the message/request acts as a trigger or activator and the ACK from the NW allows/initiates the CSI reporting procedure. The UL resource allocation (RA) for CSI report can be pre-configured (CG PUSCH), or granted (e.g. together with ACK).

In a variation of the previous example, a first DCI (as explained herein) can dynamically change/adapt information about the measurement (e.g. number of ports, power level etc.) associated with the CSI report, but does not trigger the CSI report. The trigger is UE-initiated. The NW can ACK in response to the UE-initiated trigger/request via a second DCI, and then the UE measures and reports the CSI report according to the latest update (if any) of the CSI Trigger state (via the first DCI). In one example, the first DCI and the second DCI are the same. In one example, they can be different.

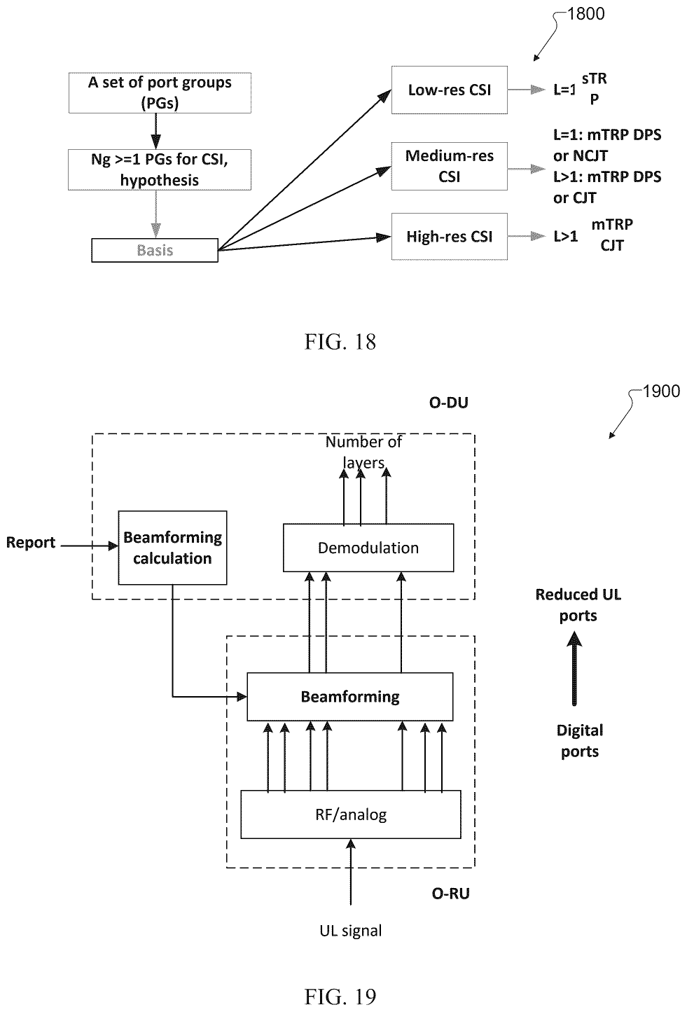

FIG. 18 illustrates an example a codebook configuration 1800 according to embodiments of the present disclosure. For example, codebook configuration 1800 can be configured by the BS 102 of FIG. 1. This example is for illustration only and other embodiments can be used without departing from the scope of the present disclosure.

In one embodiment, the UE (e.g., the UE 116) is further configured with a codebook for PMI calculation and reporting, where the codebook includes at least two components; (a) basis and (b) coefficients, as shown in FIG. 18. The basis includes L vectors (or matrices) associated with SD (across SD units such as ports or/and PGs). Additionally, the basis can also include M vectors (or matrices) associated with FD (across FD units such as PRBs or SBs), or/and Q vectors (or matrices) associated with time domain (TD)/delay domain (DD) (across TD/DD units such as time slots). The parameter (L, M, Q) can be fixed or configured (e.g. via higher layer parameter).

In one example, when L=1, the codebook corresponds to a low-resolution codebook based on a single vector, and when L>1, the codebook corresponds a high-resolution codebook based on a linear combination of multiple vectors.

When M is not provided/configured, there is no FD basis, i.e., there is no compression in FD, and hence the PMI component (i₂) for the co-phase or/and amplitude of the coefficients are reported for each SB in the CSI reporting band. When M is provided, there is FD compression across FD PRBs (cf. Rel-16 eType II codebook in 5G NR).

When Q is not provided/configured, there is no TD/DD basis, i.e., there is no compression in TD/DD. When Q is provided, there is TD/DD compression across TD/DD units or time slots (cf. Rel-18 eType II-Doppler codebook in 5G NR).

In one example, the basis vectors are DFT vectors. In one example, the basis vectors are orthogonal DFT vectors without oversampling or rotation factor (i.e. the DFT vectors are critically sampled, i.e. oversampling factor=1). In one example, the basis vectors are orthogonal DFT vectors with oversampling or rotation factor (i.e. the DFT vectors are oversampled with oversampling factor>1, e.g. 4). In one example, the SD basis vectors are orthogonal DFT vectors with oversampling or rotation factor=4. In one example, the FD or DD/TD basis vectors are orthogonal DFT vectors without oversampling or rotation factor.

In one example, when number of layers>1, precoder for each layer is calculated independently.

In one example, the structure of the precoding matrix is given by summation over up to three basis vectors:

$$p = {\sum }_{i = 0}^{L - 1} {\sum }_{f = 0}^{M - 1} {\sum }_{d = 0}^{Q - 1} {B}_{i , f , d} \times {c}_{i , f , d} or$$

$$[ \begin{matrix}{\sum }_{i = 0}^{L - 1} {\sum }_{f = 0}^{M - 1} {\sum }_{d = 0}^{Q - 1} {B}_{i , f , d} \times {c}_{i , f , d} \\ {\sum }_{i = 0}^{L - 1} {\sum }_{f = 0}^{M - 1} {\sum }_{d = 0}^{Q - 1} {B}_{i + L , f , d} \times {c}_{i + L , f , d}\end{matrix} ]$$

where B_{i,f,d} indicates a (i, f, d)-the element of the basis in three dimension, and c_{i,f,d} is the corresponding coefficient.

When there is no DD/TD compression, then

$$p = {\sum }_{i = 0}^{L - 1} {\sum }_{f = 0}^{M - 1} {B}_{i , f} \times {c}_{i , f}$$

or

$$[ \begin{matrix}{\sum }_{i = 0}^{L - 1} {\sum }_{f = 0}^{M - 1} {B}_{i , f} \times {c}_{i , f} \\ {\sum }_{i = 0}^{L - 1} {\sum }_{d = 0}^{Q - 1} {B}_{i + L , f} \times {c}_{i + L , f}\end{matrix} ] .$$

When there is no FD compression, then

$$p = {\sum }_{i = 0}^{L - 1} {\sum }_{d = 0}^{Q - 1} {B}_{i , d} \times {c}_{i , d}$$

or

$$[ \begin{matrix}{\sum }_{i = 0}^{L - 1} {\sum }_{d = 0}^{Q - 1} {B}_{i , d} \times {c}_{i , d} \\ {\sum }_{i = 0}^{L - 1} {\sum }_{d = 0}^{Q - 1} {B}_{i + L , d} \times {c}_{i + L , d}\end{matrix} ] .$$

When there is no FD and DD/TD compression, then

$$p = {\sum }_{i = 0}^{L - 1} {B}_{i} \times {c}_{i}$$

or

$$[ \begin{matrix}{\sum }_{i = 0}^{L - 1} {B}_{i} \times {c}_{i} \\ {\sum }_{i = 0}^{L - 1} {B}_{i + L} \times {c}_{i + L}\end{matrix} ] .$$

In one example, B_{i+L}=Bᵢ.

FIG. 19 illustrates an example O-RAN architecture 1900 according to embodiments of the present disclosure. For example, O-RAN architecture 1900 can be implemented in the BS 103 of FIG. 1. This example is for illustration only and other embodiments can be used without departing from the scope of the present disclosure.

In the rest of the disclosure, embodiments and examples are provided for the use case wherein a codebook (CB) and a CSI report (based on the CB) are used for UL port reduction, e.g. in a O-RAN-based PHY functionality split (as described herein). In particular, how to reduce number of ports (from O-RU to O-DU) for UL reception has been discussed. An example is illustrated in FIG. 19. The O-RU receives an UL signal, performs RF/analog processing and provides an input to a beamforming block via N digital ports. The beamforming block reduces number of ports from N ports to M ports based on an input from O-DU regarding the beamforming vector(s). The beamforming vector(s) in turn can be calculated be based on a report from the UE. This disclosure focusses on mechanisms to providing such a report.

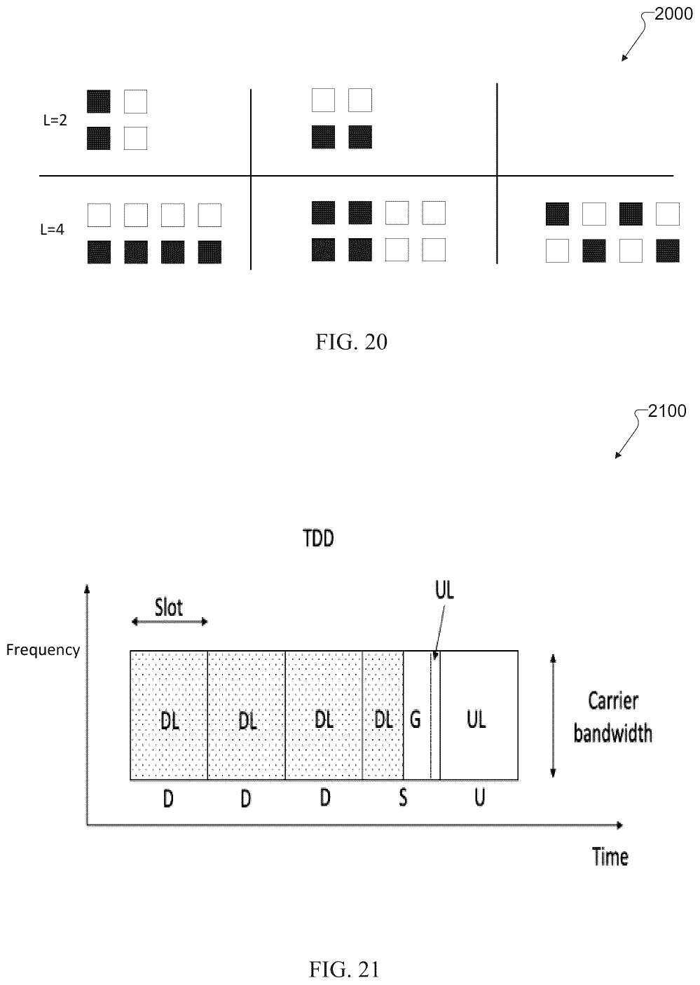

FIG. 20 illustrates examples of SD vector patterns 2000 according to embodiments of the present disclosure. For example, SD vector patterns 2000 can be utilized by any of the UEs 111-116 of FIG. 1. This example is for illustration only and other embodiments can be used without departing from the scope of the present disclosure.

In one embodiment, a UE determines a report (e.g. a CSI report as described in this disclosure), where the report includes at least L SD vector(s) and L≥1.

In one example, the report can be a standalone report (i.e. not multiplexed with any other report or UCI parameter). In one example, the report can be a non-standalone report, hence can be multiplexed together with another report or UCI parameter. When multiplexed with another report or UCI parameter, the another report can be a CSI report and the UCI parameter can be at least one of rank indicator (RI), precoding matrix indicator (PMI), channel quality indicator (CQI), CQI report interval (CRI), layer index (LI), SSB resource indicator (SSBRI), L1-RSRP, L1-SINR, and time-domain channel property (TDCP). In one example, the report can be standalone or non-standalone based on configuration (from the NW, e.g. RRC or/and MAC CE or/and DCI) or UE capability.

In one example, the UE determines a CSI report based on L₁≥1 SD vectors, and additionally, determines the report including L SD vector(s). In one example, the L SD vector(s) are independent from L₁ SD vectors. In one example, the L SD vector(s) include L₁ SD vectors, where, in one example, L=L₁ or in another example, L>L₁. The additional reporting of L SD vectors can be configurable (e.g. can be turned ON/OFF or disabled/enabled by the NW for example based on RRC or DCI or MAC CE based signaling) or optional (e.g. can be subject to UE capability). When turned ON or being capable of such reporting, the UE provides the additional L SD vectors together with the CSI report. When turned OFF or incapable of such reporting, the UE only provides the CSI report (without the additional L SD vectors).

In one embodiment, the L SD vectors (in the report as described in herein) are determined/reported according to at least one of the following examples.
In one example, they are selected freely from the set of candidate SD vectors (similar to the selection/reporting of the SD vectors in Rel-16 enhanced Type II codebook, 7.2.2.2.5 of [REF 8]).
In one example, they are selected with a restriction. For instance, the L SD vectors forms a pattern. In one example, the pattern corresponds to (l₁, l₂) rectangular pattern in 2D. For example,
   When L=2, (l₁, l₂)=(2,1) or (1,2).
   When L=3, (l₁, l₂)=(3,1).
   When L=4, (l₁, l₂)=(4,1) or (2,2) or (1,4).
   When L=6, (l₁, l₂)=(6,1) or (3,2) or (2,3) or (1,6).
   When L=8, (l₁, l₂)=(8,1) or (4,2) or (2,4) or (1,8).

A few examples of patterns are shown in FIG. 20.

In one embodiment, the value of L belongs to a set, where the set is determined/configured according to at least one of the following examples.
In one example, the set includes only one value. This only one value can be fixed or up to UE capability reporting.
In one example, the set includes multiple values.
   In one example, one value from the multiple values is configured via RRC. This configuration can be subject to UE capability reporting.
   In one example, one value from the multiple values is indicated via a code point of a field in DCI (DL-DCI or UL-DCI). This indication can be subject to UE capability reporting.
   In one example, multiple values are configured via RRC, and one value from the RRC-configured values is indicated via a code point of a field in DCI (DL-DCI or UL-DCI). This indication can be subject to UE capability reporting.
   In one example, one value from the multiple values is selected/reported by the UE. This reporting can be via a two-part UCI wherein the selected value of L is indicated via a UCI parameter in UCI part 1, and the corresponding L SD vectors are indicated via a UCI parameter in UCI part 2.

In one example, the set includes all of or a subset of values in {2, 3, 4, 6, 8}. In one example, L=1 can be a candidate value of L. In one example, a candidate value of L can only be such that L>1.

In one embodiment, each SD vector is a DFT vector.
In one example, the L SD vectors belong to a set of orthogonal DFT vectors. For example, the set of orthogonal DFT vectors can be the SD vectors vᵢ_{₁}_{^{(m)}}_{,i}_{₂}_{^{(m)}} (including rotation factors q₁, q₂) as in Rel-15/16 Type II codebook.
In one examples, the L SD vectors can belong to set of non-orthogonal or oversampled DFT vectors. For example, the set of non-orthogonal or oversampled DFT vectors can be the SD vectors vᵢ_{₁}_{^{(m)}}_{,i}_{₂}_{^{(m)}} as in Rel-15 Type I codebook.

In one embodiment, the L SD vectors are determined based on a rank value of the CSI report which the L SD vectors are multiplexed/determined together with. For instance, the UE determines a rank value (r) of the CSI report.
In one example, when r>1, then L₁>1 and the CSI report is based on L₁ SD vectors, as described herein. In this case, the L SD vectors are determined based on L₁ SD vectors of the CSI report. For instance, L SD vectors corresponds to or are included in the L₁ SD vectors.
In one example, when r=1, then L₁=1 and the CSI report is based on L₁=1 SD vector, however; the UE can report L>1 SD vectors as additional SD vectors. For instance, the first of the L SD vectors is the same as (hence used for) the CSI report, and the remaining L−1 SD vectors, not used for the CSI report, are the additional SD vectors.

In one embodiment, the UE is configured with the report including the L SD vectors subject to a condition or restriction.
In one example, the restriction/condition is based on a number of digital ports Nₚₒᵣₜ (at an O-RU or NW).
   In one example, the condition corresponds to Nₚₒᵣₜ≥t.
   In one example, the condition corresponds to Nₚₒᵣₜ>t.
In one example, the restriction/condition is based on the codebook type. For instance, the codebook type can only be low-resolution (low-res) or Type I codebook wherein a precoder (layer) is determined based on one SD vector (with a corresponding co-phase when dual-polarized antennae).

Here, t is a threshold, which can be fixed (e.g. 16, 32, 48, 64) or configured or subject to UE capability reporting.

In one embodiment, the L SD vector(s) can be ordered (for reporting via UCI).
In one example, the ordering is based on their power. For instance, the first SD vector corresponds to the highest power, the second SD vector corresponds to the second highest power and so on. In one example, when two SD vectors have the same power, then they are ordered according to their indices, e.g. either in increasing or decreasing order.
In one example, the ordering is fixed, e.g. based on their indices, either in increasing or decreasing order.
In one example, the ordering is reported. This can be implicit or explicit. When implicit, the ordering information is based on the report itself without any additional information. When explicit, the ordering information is based on an information (about the ordering) in addition to the report.

In one embodiment, the UE is further configured with a measurement of at least one DL RS associated with the report, where the DL RS can be at least one of NZP CSI-RS or SSB or DMRS or tracking reference signal TRS or phase TRS (PTRS) or path loss (PL)-RS or dedicated DL RS. The details of the at least one DL RS are as described in the disclosure.

In one example, the report can be based on a configuration/trigger from the NW (i.e., NW-controlled) or a trigger from the (i.e. UE-initiated). The details of the trigger are as described in this disclosure. When NW-controlled, the UE calculates/reports the report in response to the reception of the trigger/configuration. When UE-initiated, the UE detects/decides a need for the report, transmits the trigger followed by the report (e.g. after receiving UL resources for the report) or transmits the report (when there is UL resources already allocated for the report).

In one example, the reporting of L SD vectors is aperiodic only. When NW-triggered, the report can be triggered via a CSI request field in a DCI (e.g. UL-DCI or DL-DCI). When UE-initiated, the report can be triggered via a request field in a UCI (e.g. SR in UCI).

In one example, the FD granularity of the reporting of L SD vectors is wideband (WB), i.e., one set of L SD vectors is reported for the CSI reporting band. In one example, the FD granularity of the reporting of L SD vectors can be subband (SB), i.e., one set of L SD vectors is reported for each SB in the CSI reporting band.

In one embodiment, the UCI and UL channel/resource for reporting the L SD vectors is according to at least one of or a combination of the following examples.
In one example, the reporting of L SD vector(s) is via a dedicated indicator or UCI parameter.
   In one example, this indicator can be provided by reusing an existing indicator such as an RI in a CSI report.
   In one example, this indicator is a new indicator (other than RI/PMI/CQI/LI/CRI).
In one example, the UL resource for the report can be a layer 1 (L1) UL resource such as PUCCH or PUSCH. In this case, the report is via a UCI. Alternatively, the UL resource for the report can be a layer 1 (L2) UL resource such as PUSCH carrying a UL MAC. In this case, the report is via a MAC CE.
In one example, the reporting of the L SD vector(s) is via one-part UCI.
In one example, the reporting of the L SD vector(s) is via a two-part UCI, comprising UCI part 1 and UCI part 2.
   In one example, the reporting of the L SD vector(s) is via UCI part 1.
   In one example, the reporting of the L SD vector(s) is via UCI part 2.
   In one example, the reporting of the L SD vector(s) is via UCI part 1 and part 2. For instance, a part of the information (e.g. value of L) can be indicated via UCI part 1 and the remaining part of the information (e.g. indices of L SD vectors) can be indicated via UCI part 1.

The present disclosure relates generally to wireless communication systems and, more specifically, to interference measurement and reporting in full-duplex systems.

A communication system includes a DownLink (DL) that conveys signals from transmission points such as Base Stations (BSs) or NodeBs to User Equipments (UEs) and an UpLink (UL) that conveys signals from UEs to reception points such as NodeBs. A UE, also commonly referred to as a terminal or a mobile station, may be fixed or mobile and may be a cellular phone, a personal computer device, or an automated device. A NodeB, which is generally a fixed station, may also be referred to as an access point or other equivalent terminology. For LTE systems, a NodeB is often referred as an eNodeB (eNB). For 5G NR systems, a NodeB is often referred as an gNodeB (gNB).

In a communication system, such as LTE, 5G NR, or a next-generation system (e.g. 6G), DL signals can include data signals conveying information content, control signals conveying DL Control Information (DCI), and Reference Signals (RS) that are also known as pilot signals. An eNB/gNB (e.g., the BS 102) transmits data information through a Physical DL Shared CHannel (PDSCH). An eNB/gNB transmits DCI through a Physical DL Control CHannel (PDCCH). An eNB/gNB transmits one or more of multiple types of RS including a Channel State Information RS (CSI-RS), or a DeModulation RS (DMRS). An eNB/gNB may transmit a CSI-RS with a density in the time and/or frequency domain for the UE to perform channel measurements. DMRS can be transmitted only in the BW of a respective PDSCH and a UE can use the DMRS to demodulate data or control information in a PDSCH or a PDCCH, respectively. A transmission time interval for DL channels is referred to as a subframe or a slot, comprise multiple (e.g. 14) OFDM symbols, and can have, for example, a duration of x millisecond, where x may depend on the subcarrier spacing (SCS). For example, x=1 for SCS=15 kHz.

DL signals also include transmission of a logical channel that carries system control information. A BCCH is mapped to either a transport channel referred to as a Broadcast CHannel (BCH) when it conveys a Master Information Block (MIB) or to a DL Shared CHannel (DL-SCH) when it conveys a System Information Block (SIB)—see also REF3 and REF 5. Most system information is included in different SIBs that are transmitted using DL-SCH. A presence of system information on a DL-SCH in a subframe (or slot) can be indicated by a transmission of a corresponding PDCCH conveying a codeword with a CRC scrambled with a special System Information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe (or slot) and a group of Physical resource blocks (PRBs). A transmission BW includes frequency resource units referred to as Resource Blocks (RBs). Each RB includes N_{sc}^{RB} sub-carriers, or Resource Elements (REs), such as 12 REs. A unit of one RB over one subframe (or slot) is referred to as a PRB. A UE can be allocated M_{PDSCH} RBs for a total of M_{sc}^{PDSCH}=M_{PDSCH}·N_{sc}^{RB} REs for the PDSCH transmission BW.

UL signals can include data signals conveying data information, control signals conveying UL Control Information (UCI), and UL RS. UL RS includes DMRS and Sounding RS (SRS). A UE transmits DMRS only in a BW of a respective PUSCH or PUCCH. An eNB/gNB can use a DMRS to demodulate data signals or UCI signals. A UE transmits SRS to provide an eNB/gNB with an UL CSI. A UE transmits data information or UCI through a respective Physical UL Shared CHannel (PUSCH) or a Physical UL Control CHannel (PUCCH). If a UE needs to transmit data information and UCI in a same UL subframe (or slot), it may multiplex both in a PUSCH. UCI includes Hybrid Automatic Repeat reQuest ACKnowledgement (HARQ-ACK) information, indicating correct (ACK) or incorrect (NACK) detection for a data TB in a PDSCH or absence of a PDCCH detection (DTX), Scheduling Request (SR) indicating whether a UE has data in its buffer, and Channel State Information (CSI) enabling an eNB/gNB to perform link adaptation and DL precoding for PDSCH transmissions to a UE. HARQ-ACK information is also transmitted by a UE in response to a detection of a PDCCH indicating a release of semi-persistently scheduled PDSCH (see also REF 3).

An UL subframe can include one or multiple (e.g. 2) slots. An UL slot includes N_{symb}^{UL} symbols for transmitting data information, UCI, DMRS, or SRS. A frequency resource unit of an UL system BW is a RB. A UE is allocated N_{RB} RBs for a total of N_{RB}·N_{sc}^{RB} REs for a transmission BW. For a PUCCH, N_{RB}=1. A last subframe (or slot) symbol can be used to multiplex SRS transmissions from one or more UEs. In one example, a number of subframe (or slot) symbols that are available for data/UCI/DMRS transmission is N_{symb}=2·(N_{symb}^{UL}−1)−N_{SRS}, where N_{SRS}=1 if a last subframe (or slot) symbol is used to transmit SRS and N_{SRS}=0 otherwise.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown in Table 3. Whenever the FR2 is referred, both FR2-1 and FR2-2 frequency sub-ranges shall be expected, unless otherwise stated.

TABLE 3
Definition of frequency ranges

| Frequency range | Corresponding |
|---|---|
| designation | frequency range |

| FR1 | | 410 MHz-7125 MHz |
|---|---|---|
| FR2 | FR2-1 | 24250 MHz-52600 MHz |
| | FR2-2 | 52600 MHz-71000 MHz |

In next generation cellular standards (e.g. 6G), in addition to FR1 and FR2, new carrier frequency bands can be evaluated, e.g. terahertz (>100 GHz) and FR3 or upper mid-band (7-24 GHz). The number of antenna ports that can be supported for these new bands is likely to be different from FR1 and FR2. In particular, for 7-15 GHz band, the max number of antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (non-co-located, hence geographically separated) TRPs or O-RUs within a cellular region can be the main scenario of interest, due to which the number of CSI-RS antenna ports for MIMO can be even larger (e.g. up to 256).

A (spatial or digital) precoding/beamforming can be used across these large number of antenna ports in order to achieve MIMO gains. Depending on the carrier frequency, and the feasibility of RF/HW-related components, the (spatial) precoding/beamforming can be fully digital or hybrid analog-digital. In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across antenna ports is provided.

In one example, a TRP can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, a cell group.

In an O-RAN NW architecture, a TRP can be functionally equivalent to (hence can be replaced with) or is interchangeable with one of more of the following:
One RU or O-RU: a logical node that includes a subset of the eNB/gNB functions (e.g. as listed in clause 4.2 split option 7-2x)
More than one RUs or O-RUs
One or more than one RUs or O-RUs

Two examples are shown in FIG. 10.

The following are defined in [REF11 and REF12].

| | |
|---|---|
| O-CU | O-RAN Central Unit - a logical node hosting PDCP, RRC, SDAP and other control |
| | functions |
| O-DU | O-RAN Distributed Unit: a logical node hosting RLC/MAC/High-PHY layers based |
| | on a lower layer functional split. O-DU in addition hosts an M-Plane instance. |
| O-RU | O-RAN Radio Unit: a logical node hosting Low-PHY layer and RF processing based |
| | on a lower layer functional split. This is similar to 3GPP's “TRP” or “RRH” but |
| | more specific in including the Low-PHY layer (FFT/iFFT, PRACH extraction). O- |
| | RU in addition hosts M-Plane instance. |

FIG. 21 illustrates a timeline 2100 of example TDD according to embodiments of the present disclosure. For example, timeline 2100 can be followed by the UE 111 and the BS 103 of FIG. 1. This example is for illustration only and other embodiments can be used without departing from the scope of the present disclosure.

5G NR radio supports time-division duplex (TDD) operation and frequency division duplex (FDD) operation. Use of FDD or TDD depends on the NR frequency band and per-country allocations. TDD is required in most bands above 2.5 GHz. With reference to FIG. 21, an example structure of slots or single-carrier TDD UL-DL frame configuration for a TDD communications system is shown according to the embodiments of the disclosure.

A DDDSU UL-DL configuration is shown, where D denotes a DL slot, U denotes an UL slot, and S denotes a special or switching slot with a DL part, a flexible part that can also be used as guard period G for DL-to-UL switching, and optionally an UL part.

TDD has several advantages over FDD. For example, use of the same band for DL and UL transmissions leads to simpler UE implementation with TDD because a duplexer is not required. Another advantage is that time resources can be flexibly assigned to UL and DL taking into account an asymmetric ratio of traffic in both directions. DL is typically assigned most time resources in TDD to handle DL-heavy mobile traffic. Another advantage is that channel state information (CSI) can be more easily acquired via channel reciprocity. This reduces an overhead associated with CSI reports especially when there are many antennas or antenna elements.

Although there are advantages of TDD over FDD, there are also disadvantages. A first disadvantage is a smaller coverage of TDD due to the usually small portion of time resources available for UL transmissions, while with FDD time resources can be used for UL transmissions. Another disadvantage is latency. In TDD, a timing gap between DL reception and UL transmission containing the hybrid automatic repeat request acknowledgement (HARQ-ACK) information associated with DL receptions is typically larger than that in FDD, for example by several milliseconds. Therefore, the HARQ round trip time in TDD is typically longer than that with FDD, especially when the DL traffic load is high. This causes increased UL user plane latency in TDD and can cause data throughput loss or even HARQ stalling when a PUCCH providing HARQ-ACK information needs to be transmitted with repetitions to improve coverage (an alternative in such case is for a network (e.g., the network 130) to forgo HARQ-ACK information at least for some transport blocks in the DL).

To address some of the disadvantages for TDD operation, a dynamic adaptation of link direction has been evaluated where except for some symbols in some slots supporting predetermined transmissions such as for SSBs, symbols of a slot can have flexible transmission direction, e.g., DL or UL, which a UE (e.g., the UE 116) can determine according to scheduling information for transmissions or receptions. A PDCCH can also be used to provide a DCI format, such as a DCI format 20, that can indicate a link direction of some flexible symbols in one or more slots. Nevertheless, in actual deployments, it is difficult for a gNB scheduler to adapt a transmission direction of symbols without coordination with other gNB schedulers in the network. This is because of cross-link interference (CLI) where, for example, DL receptions in a cell by a UE can experience large interference from UL transmissions in the same or neighboring cells from other UEs.

Full-duplex (FD) communications offer increased spectral efficiency, improved capacity, and reduced latency in wireless networks. When using FD communications, UL and DL signals are simultaneously received and transmitted on fully or partially overlapping, or adjacent, frequency resources, thereby improving spectral efficiency and reducing latency in user and/or control planes.

There are several options for operating a full-duplex wireless communication system. For example, a single carrier may be used such that transmissions and receptions are scheduled on same time-domain resources, such as symbols or slots. Transmissions and receptions on same symbols or slots may be separated in frequency, for example by being placed in non-overlapping sub-bands. An UL frequency sub-band, in time-domain resources that also include DL frequency sub-bands, may be allocated in the center of a carrier, or at the edge of the carrier, or at a selected frequency-domain position of the carrier. The allocations of DL sub-bands and UL sub-bands may partially or fully overlap. A gNB may simultaneously transmit and receive in time-domain resources using same physical antennas, antenna ports, antenna panels and transmitter-receiver units (TRX). Transmission and reception in FD may also occur using separate physical antennas, ports, panels, or TRXs. Antennas, ports, panels, or TRXs may also be partially reused, or only respective subsets can be active for transmissions and receptions when FD communication is enabled.

When a UE receives signals/channels from a gNB on a full-duplex slot or symbol, the receptions may be scheduled in a DL subband of the full-duplex slot or symbol. When full-duplex operation at the gNB uses a DL slot or symbol for scheduling transmissions from the UE using full-duplex transmission and reception at the gNB, there may be one or multiple, such as two, DL subbands on the full-duplex slot or symbol. When a UE is scheduled to transmit on a full-duplex slot or symbol, the transmission may be scheduled in an UL subband of the full-duplex slot or symbol. When full-duplex operation at the gNB uses an UL slot or symbol for purpose of scheduling transmissions to UEs using full-duplex transmission and reception at the gNB, there may be one or multiple, such as two, UL subbands in the full-duplex slot or symbol. Full-duplex operation using an UL subband or a DL subband may be referred to as Subband-Full-Duplex (SBFD).

For example, when full-duplex operation at the gNB uses a DL or F slot or symbol for scheduling transmissions from the UE using full-duplex transmission and reception at the gNB, there may be one DL subband on the full-duplex slot or symbol and one UL subband of the full-duplex slot or symbol in the NR carrier. A frequency-domain configuration of the DL and UL subbands may then be referred to as ‘DU’ or ‘UD’, respectively, depending on whether the UL subband is configured/indicated in the upper or the lower part of the NR carrier. In another example, when full-duplex operation at the gNB uses a DL or F slot or symbol for scheduling transmissions from the UE using full-duplex transmission and reception at the gNB, there may be two, DL subbands and one UL subband on the full-duplex slot or symbol. A frequency-domain configuration of the DL and UL subbands may then be referred to as ‘DUD’ when the UL subband is configured/indicated in a part of the NR carrier and the DL subbands are configured/indicated at the edges of the NR carrier, respectively.

In the following, for brevity, full-duplex slots/symbols and SBFD slots/symbols may be jointly referred to as SBFD slots/symbol and non-full-duplex slots/symbols and normal DL or UL slot/symbols may be referred to as non-SBFD slots/symbols.

Instead of using a single carrier, different component carriers (CCs) can be used for receptions and transmissions by a UE. For example, receptions by a UE can occur on a first CC and transmissions by the UE occur on a second CC having a small, including zero, frequency separation from the first CC.

Furthermore, a gNB can operate with full-duplex mode even when a UE still operates in half-duplex mode, such as when the UE can either transmit and receive at a same time, or the UE can also be capable for full-duplex operation.

Full-duplex transmission/reception is not limited to gNBs, TRPs, or UEs, but can also be used for other types of wireless nodes such as relay or repeater nodes.

Throughout the present disclosure, Full-Duplex (FD) is used as a short form for a full-duplex operation in a wireless system. The terms “Cross-Division-Duplex (XDD)” and FD or SBFD can be used interchangeably used in the disclosure.

FD operation in NR can improve spectral efficiency, link robustness, capacity, and latency of UL transmissions. In an NR TDD system, UL transmissions are limited by fewer available transmission opportunities than DL receptions. For example, for NR TDD with SCS=30 kHz, DDDU (2 msec), DDDSU (2.5 msec), or DDDDDDDSUU (5 msec), the UL-DL configurations allow for an DL:UL ratio from 3:1 to 4:1. Any UL transmission can only occur in a limited number of UL slots, for example every 2, 2.5, or 5 msec, respectively.

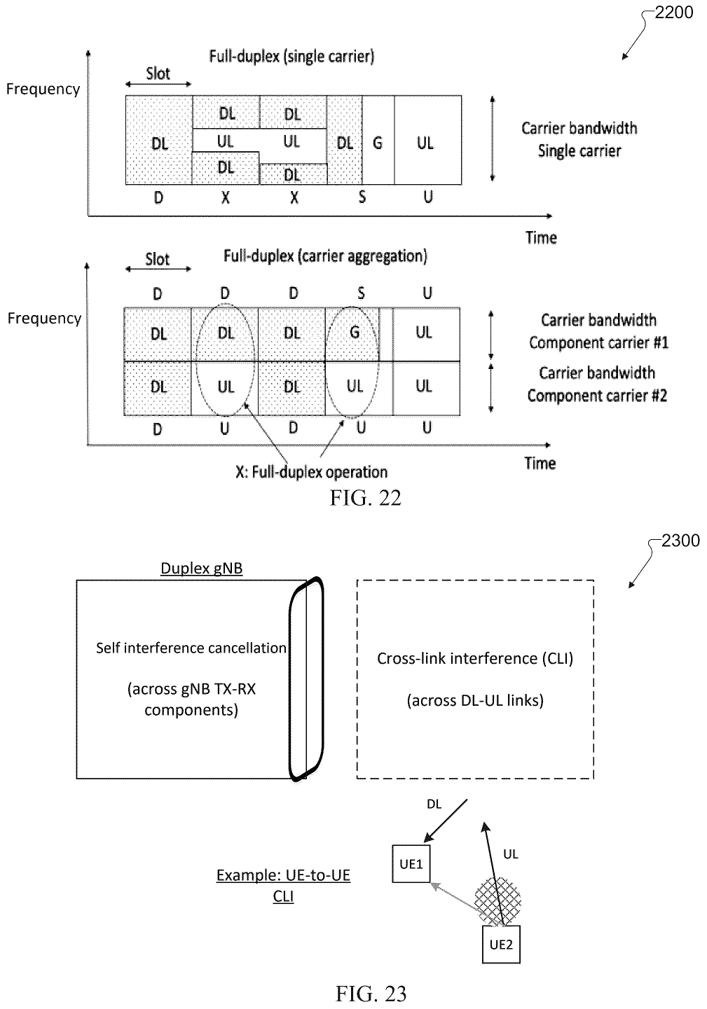

FIG. 22 illustrates timelines 2200 of example TDD according to embodiments of the present disclosure. For example, timelines 2200 can be followed by the UE 116 and the BS 102 of FIG. 1. This example is for illustration only and other embodiments can be used without departing from the scope of the present disclosure.

With reference to FIG. 22, two example full-duplex configurations using single- and multi-carrier UL-DL frame configurations are shown according to embodiments of the disclosure.

For a single carrier TDD configuration with full-duplex enabled, slots denoted as X are full-duplex or XDD or SBFD slots. Both DL and UL transmissions can be scheduled in FD slots for at least one or more symbols. The term FD slot is used to refer to a slot where UEs can simultaneously both receive and transmit in at least one or more symbols of the slot if scheduled or assigned radio resources by the base station. A half-duplex UE cannot both transmit and receive simultaneously in an FD slot or on a symbol(s) of an FD slot. When a half-duplex UE is configured for transmission in symbols of an FD slot, another UE can be configured for reception in the symbols of the FD slot. A full-duplex UE can transmit and receive simultaneously in symbols of an FD slot, possibly in presence of other UEs scheduled or assigned resources for either DL or UL in the symbols of the FD slot. Transmissions by a UE in a first FD slot can use same or different frequency-domain resources than in a second FD slot, wherein the resources can differ in bandwidth, a first RB, or a location of the center carrier.

For a carrier aggregation TDD configuration with FD enabled, a UE receives in a slot on CC #1 and transmits in at least one or more symbol(s) of the slot on CC #2. In addition to D slots used only for transmissions/receptions by a gNB/UE, U slots used only for receptions/transmissions by the gNB/UE, and S slots for also supporting DL-UL switching, full-duplex slots with both transmissions/receptions by a gNB or a UE that occur on same time-domain resources, such as slots or symbols, are labeled by X. For the example of TDD with SCS=30 kHz, single carrier, and UL-DL allocation DXXSU (2.5 msec), the second and third slots allow for full-duplex or SBFD operation. UL transmissions can also occur in a last slot (U) where the full UL transmission bandwidth is available. FD or SBFD slots or symbol assignments over a period of time and/or a number of slots or symbols can be indicated by a DCI format in a PDCCH reception and can then vary per unit of the time period, or can be indicated by higher layer signaling, such as via a MAC CE or RRC.

In next generation MIMO systems, the number of antenna ports is expected to increase further (e.g. up to 256), for example, for carrier frequencies in upper mid-band (10-15 GHz); the NW deployments are likely to be denser/more distributed (when compared with 5G NR); and the system is expected to work seamlessly even in challenging scenarios such as medium-high (e.g. 120 kmph) speed UEs, ‘higher-order) multi-user MIMO. The CSI in such systems may need to be high resolution (higher than Type II CSI in 5G NR) while keeping the UE complexity (associated with CSI calculation) and CSI overhead (number of bits to report the CSI) still manageable (e.g. similar to that for 5G NR Type II CSI).

FIG. 23 illustrates examples of interferences 2300 according to embodiments of the present disclosure. For example, interferences 2300 can interfere in the BS 102 of FIG. 2. This example is for illustration only and other embodiments can be used without departing from the scope of the present disclosure.

An evolution path for the next generation MIMO systems is to enhance a duplex scheme toward providing full duplex capability in a given slot/symbol. Full duplex operation, however, needs to overcome several challenges to be functional in actual deployments. When using overlapping frequency resources, received signals are subject to co-channel cross-link interference (CLI) and self-interference. CLI and self-interference cancellation methods include passive methods that rely on isolation between transmit and receive antennas, active methods that utilize RF or digital signal processing, and hybrid methods that use a combination of active and passive methods. Filtering and interference cancellation may be implemented in RF, baseband (BB), or in both RF and BB. While mitigating co-channel CLI may require large complexity at a receiver, it is feasible within current technological limits. Another aspect of FD operation is the mitigation of adjacent channel CLI because in several cellular band allocations, different operators have adjacent spectrum.

Interference handling is a key aspect for a Duplex system. As shown in FIG. 23, the interference can be one or more of the following types:
Self-interference cancellation (SIC)
Cross-link-interference (CLI) handling
   Intra-site, inter-sector co-channel interference
   Inter-gNB CLI mitigation/handling (i.e., UL from gNB1 interferes with DL to gNB2)
   Inter-UE CLI mitigation/handling (i.e., UL from UE1 interferes with DL to UE2)

An example of inter-UE CLI is also shown.

In an advanced duplex operation, CLI measurement and reporting can improve performance, or may in fact be critical/required for the system operations. This disclosure provides mechanisms to such measurement and reporting.

The present disclosure relates to a full duplex system. In particular, it relates to the CLI measurement and reporting for a xUE (UE-to-UE) co-channel CLI. 3 aspects are as follows:
Measurement: RS type, configuration/trigger
Report: metric or reportQuantity, granularity, TD behavior
NW-trigger, UEI

In the following, for brevity, both FDD and TDD are regarded as the duplex method for both DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure covers several components which can be used in conjunction or in combination with one another, or can operate as standalone schemes.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” or bandwidth part (BWP) can also be used.

In terms of UE configuration, a UE can be configured with at least one CSI reporting band. This configuration can be semi-static (via higher-layer signaling or RRC) or dynamic (via MAC CE or L1 DL control signaling). When configured with multiple (N) CSI reporting bands (e.g. via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for the Mₙ subbands within the CSI reporting band. A CSI parameter is configured with “subband” for the CSI reporting band with Mₙ subbands when one CSI parameter is reported for each of the Mₙ subbands within the CSI reporting band.

In the following, N₁ and N₂ are the number of antenna ports with the same polarization in the first and second dimensions, respectively. For 2D antenna port layouts, N₁>1, N₂>1, and for 1D antenna port layouts either N₁>1 and N₂=1 or N₂>1 and N₁=1. In the rest of the disclosure, 1D antenna port layouts with N₁>1 and N₂=1 is provided. The disclosure, however, is applicable to the other 1D port layouts with N₂>1 and N₁=1. Also, in the rest of the disclosure, N₁>N₂. The disclosure, however, is applicable to the case when N₁<N₂, and the embodiments for N₁>N₂ apply to the case N₁<N₂ by swapping/switching (N₁, N₂) with (N₂, N₁). For a single-polarized (or co-polarized) antenna port layout, the total number of antenna ports is P_{CSIRS}=N₁N₂. And, for a dual-polarized antenna port layout, the total number of antenna ports is P_{CSIRS}=2N₁N₂. An illustration is shown in FIG. 13 where “X” represents two antenna polarizations (dual-pol, s=2) and “/” represents one antenna polarization (co-pol, s=1). In this disclosure, the term “polarization” refers to a group of antenna ports with the same polarization. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g. X=3000, then antenna ports are 3000, 3001, 3002, . . . ). Unless stated otherwise, dual-polarized antenna layouts are expected in this disclosure. The embodiments (and examples) in this disclosure however are general and are applicable to single-polarized antenna layouts as well.

Let s denotes the number of antenna polarizations (or groups of antenna ports with the same polarization). Then, for co-polarized antenna ports, s=1, and for dual- or cross (X)-polarized antenna ports s=2. So, the total number of antenna ports P_{CSIRS}=sN₁N₂.

Let N_{g} be a number of antenna/port groups (PGs). When there are multiple antenna/port groups (N_{g}>1), each group (g∈{1, . . . , N_{y}}) comprises N_{1,g} and N_{2,g} ports in two dimensions. This is illustrated in FIG. 13. Note that the antenna port layouts may be the same (N_{1,g}=N₁ and N_{2,g}=N₂) in different antenna/port groups, or they can be different across antenna/port groups. For group g, the number of antenna ports is P_{CSIRS,g}=N_{1,g}N_{2,g} or 2N_{1,g}N_{2,g} (for co-polarized or dual-polarized respectively), i.e., P_{CSIRS,g}=s_{g}N_{1,g}N_{2,g} where s_{g}=1 or 2.

In one example, an antenna/port group corresponds to an antenna panel. In one example, an antenna/port group corresponds to a TRP. In one example, an antenna/port group corresponds to an RRH. In one example, an antenna/port group corresponds to CSI-RS antenna ports of a NZP CSI-RS resource. In one example, an antenna/port group corresponds to a subset of CSI-RS antenna ports of a NZP CSI-RS resource (comprising multiple antenna/port groups). In one example, an antenna/port group corresponds to CSI-RS antenna ports of multiple NZP CSI-RS resources (e.g. comprising a CSI-RS resource set).

In one example, an antenna/port group corresponds to a reconfigurable intelligent surface (RIS) in which the antenna/port group can be (re-)configured more dynamically (e.g. via MAC CE or/and DCI). For example, the number of antenna ports associated with the antenna/port group can be changed dynamically.

In one example, the antenna architecture of the MIMO system is structured. For example, the antenna structure at each PG or O-RU (or RU) is dual-polarized (single or multi-panel) as shown in FIG. 13. The antenna structure at each PG or O-RU (or RU) can be the same. Or, the antenna structure at an PG or O-RU (or RU) can be different from another PG or O-RU (or RU). Likewise, the number of ports at each PG (or O-RU or RU) can be the same. Or, the number of ports at one PG (or O-RU or RU) can be different from another PG (or O-RU or RU).

In another example, the antenna architecture of the MIMO system is unstructured. For example, the antenna structure at one PG (or O-RU or RU) can be different from another PG (or O-RU or RU).

A structured antenna architecture is provided in the rest of the disclosure. For simplicity, each PG (or O-RU or RU) is equivalent to a panel (cf. FIG. 13), although, an PG (or O-RU or RU) can have multiple panels in practice. The disclosure however is not restrictive to a single panel assumption at each PG (or O-RU or RU), and can easily be extended (covers) the case when an PG (or O-RU or RU) has multiple antenna panels.

In one embodiment, an PG (or O-RU or RU) constitutes (or corresponds to or is equivalent to) at least one of the following:
In one example, an PG or O-RU (or RU) corresponds to a TRP.
In one example, an PG or O-RU (or RU) corresponds to a CSI-RS resource. A UE is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained in this disclosure.
In one example, an PG or O-RU (or RU) corresponds to a CSI-RS resource group, where a group comprises one or multiple NZP CSI-RS resources. A UE is configured with K≥N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained in this disclosure. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.
In one example, an PG or O-RU (or RU) corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an PG or O-RU (or RU). The information about the subsets of ports or grouping of ports can be provided together with the CSI-RS resource setting/configuration, or with the CSI reporting setting/configuration, or with the CSI-RS resource configuration.
In one example, an PG or O-RU (or RU) corresponds to one or more examples described herein depending on a configuration. For example, this configuration can be explicit via a parameter (e.g. an RRC parameter). Or, it can be implicit.
   In one example, when implicit, it could be based on the value of K. For example, when K>1 CSI-RS resources, an PG or O-RU (or RU) corresponds to one or more examples described herein, and when K=1 CSI-RS resource, an PG or O-RU (or RU) corresponds to one or more examples described herein.
   In another example, the configuration could be based on the configured codebook. For example, an PG or O-RU (or RU) corresponds to a CSI-RS resource (according to one or more examples described herein) or resource group (according to one or more examples described herein) when the codebook corresponds to a decoupled codebook (modular or separate codebook for each PG or O-RU (or RU)), and an PG or O-RU (or RU) corresponds to a subset (or a group) of CSI-RS ports (according to one or more examples described herein) when codebook corresponds to a coupled (joint or coherent) codebook (one joint codebook across PGs).

In one example, when PG or O-RU (or RU) maps (or corresponds to) a CSI-RS resource or resource group (according to one or more examples described herein), and a UE can select a subset of PGs (resources or resource groups) and report the CSI for the selected PGs (resources or resource groups), the selected PGs can be reported via an indicator. For example, the indicator can be a CRI or a PMI (component) or a new indicator.

In one example, when PG or O-RU (or RU) maps (or corresponds to) a CSI-RS port group (according to one or more exampled described herein), and a UE can select a subset of PGs (port groups) and report the CSI for the selected PGs (port groups), the selected PGs can be reported via an indicator. For example, the indicator can be a CRI or a PMI (component) or a new indicator.

In one example, when multiple (K>1) CSI-RS resources are configured for N_{g} PGs (according to one or more examples described herein), a decoupled (modular) codebook is used/configured, and when a single (K=1) CSI-RS resource for N_{g} PGs (according to one or more examples described herein), a joint codebook is used/configured.

In the following and throughout the disclosure, various embodiments of the disclosure may be also implemented in any type of UE including, for example, UEs with the same, similar, or more capabilities compared to 5G NR UEs. Although various embodiments of the disclosure discuss 3GPP 5G NR communication systems, the embodiments may apply in general to UEs operating with other RATs and/or standards, such as next releases/generations of 3GPP, IEEE WiFi, and so on.

In the following, unless otherwise explicitly noted, providing a parameter value by higher layers includes providing the parameter value by a system information block (SIB), such as a SIB1, or by a common RRC signaling, or by UE-specific RRC signaling.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE (e.g., the UE 116) determines a common TDD UL-DL frame configuration of a serving cell by receiving a SIB such as a SIB1 when accessing the cell from RRC_IDLE or by RRC signaling when the UE is configured with an SCell or additional secondary cell groups (SCGs) by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration designates a slot or symbol as one of types ‘D’, ‘U’ or ‘F’ using at least one time-domain pattern with configurable periodicity.

In the following, for brevity of description, SFI refers to a slot format indicator as example that is indicated using higher layer provided IEs such as slotFormatCombination or slotFormatCombinationsPerCell and which is indicated to the UE by group common DCI format such as DCI F2_0 where slotFormats are defined in REF7.

In the following, for brevity of description, the parameter/IE ‘fd-config’ is used to describe the configuration and parameterization for UE determination of receptions and/or transmissions in a serving cell supporting full-duplex operation. For example, the UE may be provided with the set of RBs or set of symbols of an SBFD UL or DL subband. It is not necessary that the use of full-duplex operation by a gNB (e.g., the BS 102) in the serving cell when scheduling to a UE receptions and/or transmissions in a slot or symbol is identifiable by or known to the UE. For example, parameters associated with the parameter ‘fd-config’ may include a set of time-domain resources, e.g., symbols/slots, where receptions or transmissions by the UE are allowed, possible, or disallowed; a range or a set of frequency-domain resources, e.g., serving cells, BWPs, start and/or end or a set of RBs, where receptions or transmissions by the UE are allowed, possible, or disallowed; one or multiple guard intervals for time and/or frequency domain radio resources during receptions or transmissions by the UE, e.g., guard SCs or RBs, guard symbols; one or multiple resource types, e.g., ‘simultaneous Tx-Rx’, ‘Rx only’, or ‘Tx only’ or ‘D’, ‘U’, ‘F’, ‘N/A’; one or multiple scheduling behaviors, e.g., “DG only”, “CG only”, “any”. Configuration and/or parameters associated with the fd-config may include indications or values to determine Tx power settings of receptions by the UE, such as, reference power, energy per resource element (EPRE), or power offset of a designated channel/or signal type transmitted by a serving gNB; to determine the power and/or spatial settings for transmissions by the UE. Configuration and/or parameters associated with the fd-config may be provided to the UE using higher layer signaling, DCI-based signaling, and/or MAC CE based signaling. For example, configuration and/or parameters associated withfd-config may be provided to the UE by means of common RRC signaling using SIB or by UE-dedicated RRC signaling such as ServingCellConfig. For example, configuration and/or parameters associated with fd-config may be provided to the UE using an RRC-configured time domain resource assignment (TDRA) table, or a PDCCH, PDSCH, PUCCH or PUSCH configuration, and/or DCI-based signaling that indicates to the UE a configuration for the UE to apply.

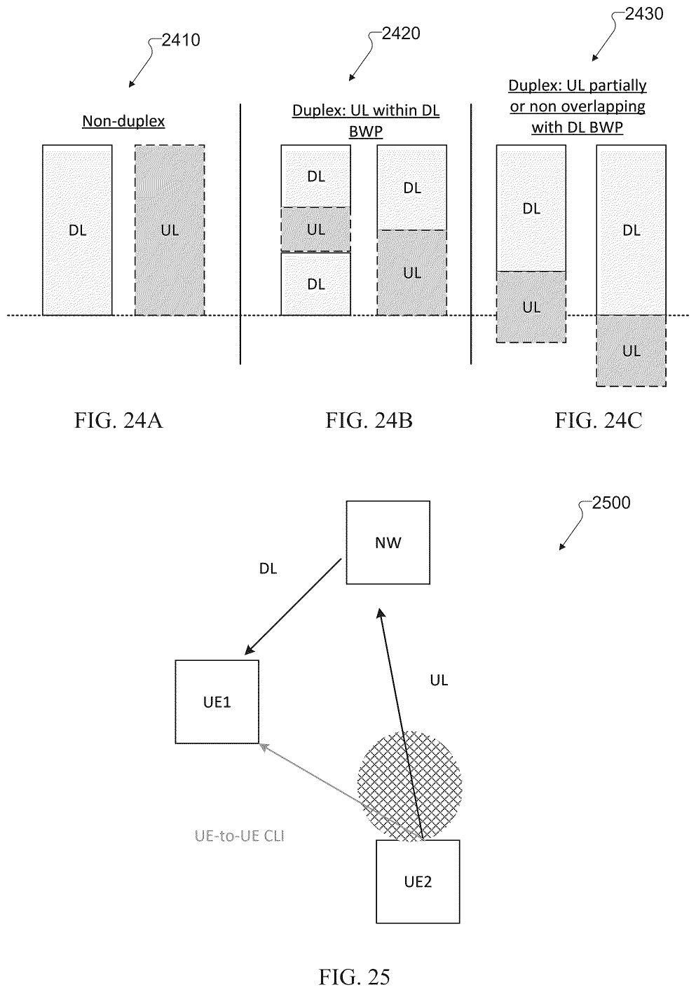

FIG. 24A illustrates an example of non-duplex architecture 2410 according to embodiments of the present disclosure. For example, non-duplex architecture 2410 can be implemented within the wireless network 100 of FIG. 1. This example is for illustration only and other embodiments can be used without departing from the scope of the present disclosure.

FIGS. 24B and 24C illustrate examples of duplex architecture 2420 and 2430 according to embodiments of the present disclosure. For example, duplex architecture 2420 and 2430 can be implemented within the wireless network 100 of FIG. 1. This example is for illustration only and other embodiments can be used without departing from the scope of the present disclosure.

In the following, for brevity, full-duplex slots/symbols and SBFD slots/symbols may be jointly referred to as SBFD slots/symbol and non-full-duplex slots/symbols and normal DL/UL slot/symbols may be jointly referred to as non-SBFD slots/symbols or regular slots/symbols.

With reference to FIG. 24, a few examples are shown of duplex operation wherein there is an UL SB in the same slot as the DL BWP, and the UL SB is either completely within DL BWP (hence is fully overlapping, either surrounded by two DL SBs or at one end of DL BWP) or partially overlapping with the DL BWP or non-overlapping with the DL BWP. Note that the term ‘SB’ here is different from that used for SB reporting of a quantity such as CQI. Here, UL SB refers to a part of the DL BWP in a DL slot that is configured for UL transmission. The rest of DL BWP in the same DL slot is used for normal DL reception.

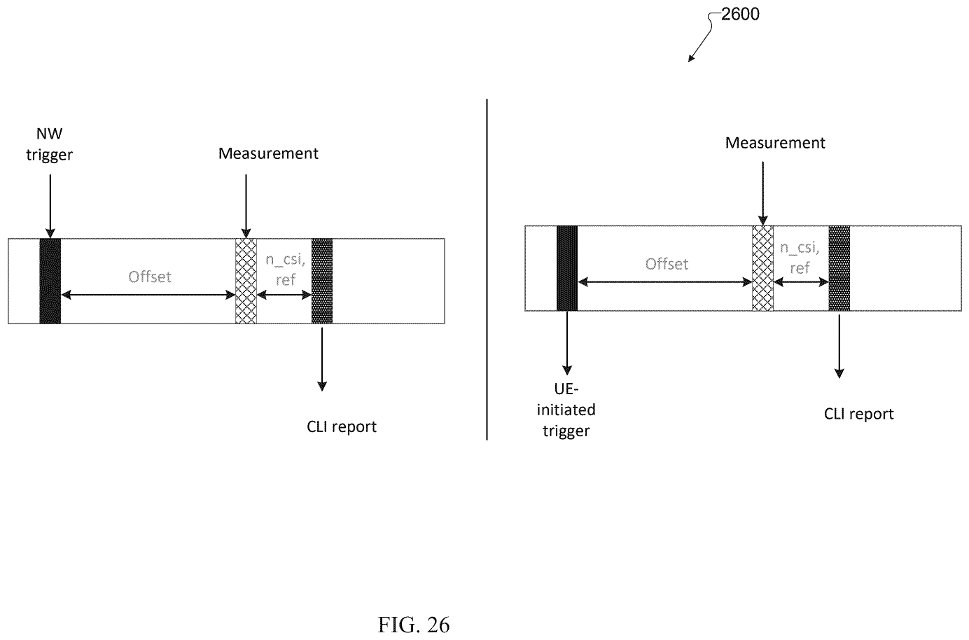

FIG. 25 illustrates an example of UE-to-UE CLI 2500 according to embodiments of the present disclosure. For example, UE-to-UE CLI 2500 can interfere between the UE 115 and the UE 116 in the wireless network 100 of FIG. 1. This example is for illustration only and other embodiments can be used without departing from the scope of the present disclosure.

In one embodiment, a UE is configured with K≥1 RS(s) linked (or associated) with a CLI. The configuration includes frequency/time location of K RS(s). In one example, the RS(s) are measurement RS(s) that the UE is configured to receive, and CLI is (or determined) based on the measurement on the K measurement RS(s). In one example, the RS(s) are measurement RS(s) that the UE is configured to transmit, and the transmission of the K measurement RS(s) is to facilitate an information about CLI. The CLI can be associated with (or can corresponds to) a CLI metric M or/and a corresponding RS I. Or, The CLI can be associated with (or can corresponds to) up to N CLI metrics {Mₙ} or pairs {(Mₙ, Iₙ)}, where Mₙ and Iₙ are n-th CLI metric and corresponding RS. In one example, the value of N is fixed (e.g. 1 or 2 or 4). In one example, the value of N is configured (e.g. via a RRC parameter), indicated via DCI field. In one example, the value of N is reported by the UE together with the CLI report. When N is reported, it can be reported via a UCI parameter in UCI part 1 of a two-part UCI, and the N CLI reports can be reported via UCI part 2 of the (same) two-part UCI. In one example, the value of N belongs to a set including {1,2,3,4}.

In one example, the information about K RSs is according to at least one of the following examples.
In one example, the information is a list of K RS(s).
In one example, the information is a list of ID(s) of K RS(s).
In one example, the information is an ID of (resource) list/set, which in turn includes K RS(s) or ID(s) of K RS(s).
In one example, the information is IE (or an ID of) CLI-ResourceConfig or CSI-ResourceConfig or CSI-RS-Config, which includes K RS(s) or ID(s) of K RS(s) or ID of (resource) list/set which in turn includes K RS(s) or ID(s) of K RS(s).

In one example, the L1 CLI metric is according to at least one of the following examples.

In one example, the CLI metric includes received signal strength indicator (RSSI) or L1-RSSI. In one example, RSSI or L1-RSSI comprises the linear average of the total received power (in [W]) observed only per configured OFDM symbol and in the measurement bandwidth indicated by higher layers or corresponding to the channel bandwidth defined in Clause 4 of TS 37.213, where the channel has the center frequency configured by ARFCN-valueNR, by the UE from sources, including co-channel serving and non-serving cells, adjacent channel interference, thermal noise etc. Higher layers configure the ARFCN-valueNR, the reference numerology and the measurement duration, i.e., which OFDM symbol(s) should be measured by the UE. For frequency range 1, the reference point for the RSSI shall be the antenna connector of the UE. For frequency range 2, RSSI shall be measured for each receiver branch based on the combined signal from antenna elements corresponding to the receiver branch. For frequency range 1 and 2, if receiver diversity is in use by the UE, the reported RSSI value shall not be lower than the corresponding RSSI of any of the individual receiver branches.

In one example, the CLI metric includes SRS reference signal received power (SRS-RSRP) or L1-SRS-RSRP. In one example, SRS-RSRP or L1-SRS-RSRP is defined as linear average of the power contributions (in [W]) of the resource elements carrying sounding reference signals (SRS). SRS-RSRP shall be measured over the configured resource elements within the measurement frequency bandwidth in the configured measurement time occasions. For frequency range 1, the reference point for the SRS-RSRP shall be the antenna connector of the UE. For frequency range 2, SRS-RSRP shall be measured based on the combined signal from antenna elements corresponding to a given receiver branch. For frequency range 1 and 2, if receiver diversity is in use by the UE, the reported SRS-RSRP value shall not be lower than the corresponding SRS-RSRP of any of the individual receiver branches.

The K RS(s) corresponds to SRS(s), and the SRS(s) (or resources) may be configured for SRS-RSRP measurement for CLI. In one example, the UE is not expected to measure SRS-RSRP with a subcarrier spacing other than the one configured for the active BWP confining the SRS resource. In one example, the UE is not expected to measure SRS-RSRP using the SRS-RSRP measurement resource which is not fully confined within the DL active BWP. In one example, the UE is not expected to measure more than 32 SRS resources, and the UE is not expected to receive more than 8 SRS resources in a slot.

In one example, the CLI metric include CLI received signal strength indicator (CLI-RSSI) or L1-CLI-RSSI. In one example, CLI-RSSI or L1-CLI-RSSI is defined as linear average of the total received power (in [W]) observed only in the configured OFDM symbols of the configured measurement time resource(s), in the configured measurement bandwidth from sources, including co-channel serving and non-serving cells, adjacent channel interference, thermal noise etc. For frequency range 1, the reference point for the RSSI shall be the antenna connector of the UE. For frequency range 2, CLI-RSSI shall be measured based on the combined signal from antenna elements corresponding to a given receiver branch. For frequency range 1 and 2, if receiver diversity is in use by the UE, the reported CLI-RSSI value shall not be lower than the corresponding CLI-RSSI of any of the individual receiver branches.

In one example, the UE-to-UE (or xUE) CLI measurement is based on at least one of the following methods:
In Method 1, a victim UE measures RSSI or L1-RSSI or CLI-RSSI or L1-CLI-RSSI within DL SB.
In Method 2, a victim UE measures SRS-RSRP or L1-SRS-RSRP of an aggressor UE within UL SB.
In Method 3, a victim UE measures RSSI or L1-RSSI or CLI-RSSI or L1-CLI-RSSI within UL SB.

Here, the victim UE measures CLI, and the aggressor UE causes the CLI (e.g. while transmitting UL). In one example, the CLI is only measured within DL BWP, when UL SB is confined within DL BWP.

When there are multiple DL SBs (e.g. two DL SBs in FIG. 24), for UE-to-UE CLI-RSSI measurement/report across DL SBs, at least one of the following methods can be used.
In Method 1A, separate CLI-RSSI measurement resources/reports in each DL SB.
In Method 1B, CLI-RSSI measure/report in one DL SB only.
In Method 1C, CLI-RSSI measurement/report based on non-contiguous CLI-RSSI resource across DL SBs.

Method 1A allows flexible configuration of measurement reporting in one DL SB or multiple DL SBs but it consumes multiple CLI-RSSI measurement resources. Method 1B restricts gNB configuration flexibility and does not account for whether or not the CLI is asymmetric across two DL SBs. This method does not consume multiple CLI-RSSI measurement resources. Method 1C requires additional specification efforts to support non-contiguous CLI-RSSI resource allocation across DL SBs (akin to non-contiguous CSI-RS resource allocation). A single CLI-RSSI report based on non-contiguous CLI-RSSI resource may be sufficient.

In one example, the K measurement RS(s) are periodic, semi-persistent, aperiodic or event triggered RS(s).

In one example, the K measurement RS(s) are CLI-RSSI RS (or resources).

In one example, the K measurement RS(s) are SRS (or SRS-RSRP) resources. In one example, the number of SRS ports is fixed (e.g. 1 or 2) when the SRS is configured/used for CLI reporting. In one example, SRS measurement is configured to be within the UL SB. In one example, SRS measurement can be configured to be within the DL SB. In one example, SRS measurement can be configured to be within the DL SB or the UL SB. In one example, SRS measurement can be configured to be within the entire DL BWP.

In one example, the K measurement RS(s) are dedicated UL interference measurement RSs (UL IMRs). In one example, the UL IMR(s) can only be configured in the UL SB. In one example, the time-frequency (T-F) allocation (patterns), i.e., set of REs in each PRB within the CLI measurement/reporting band is the same as the T-F pattern/allocation for at least one of DL IMRs (e.g. NZP CSI-RS based IMR or CSI-IM based IMR) or the T-F pattern/allocation of a 1-port SRS or 1-port DMRS.

In one example, the K measurement RS(s) can also be UL DMRS(s), either PUCCH DMRS or/and PUSCH DMRS or/and PRACH DMRS.

In one example, the K measurement RS(s) can be DL RS(s) such as NZP CSI-RS(s) or/and ZP CSI-RS(s) or/and CSI-IM(s) or DL DMRS(s).

In one example, the K measurement RS(s) can be DL IMR(s), which can be same as DL IMR(s) for CSI report (PMI/CQI/RI/LI/CRI) or beam report (CRI/RSRP or SSBRI/RSRP or CRI/L1-SINR or SSBRI/L1-SINR), or it can be DL IMR(s) specific for CLI reporting, hence can be different from IMR(s) for CSI/beam report.

In one example, the K measurement RS(s) are configured via an IE CLI-ResourceConfig or CSI-ResourceConfig. An example is shown in Table 4 when the measurement RS(s) are SRS. An example is shown in Table 5 when the measurement RS(s) are RSSI resources. An example is shown in Table 6 when the measurement RS(s) are SRS or RSSI resources.

TABLE 4

| | |
|---|---|
| CLI-ResourceConfig ::= | SEQUENCE { |
| cli-ResourceConfigId | CLI-ResourceConfigId, |

SRS-ResourceListConfigCLI ::= SEQUENCE (SIZE (1.. maxNrofCLI-SRS-Resources)) OF SRS-
ResourceConfigCLI

| SRS-ResourceConfigCLI ::= | SEQUENCE { | |
|---|---|---|
| srs-Resource | SRS-Resource, | |
| srs-SCS | SubcarrierSpacing, | |
| refServCellIndex | ServCellIndex | OPTIONAL, -- Need S |

| | |
|---|---|
| refBWP | BWP-Id, |

```
    ...
  }
```

Here, refBWP is DL BWP ID that is used to derive the reference point of the SRS resource; refServCellIndex is the index of the reference serving cell that the refBWP belongs to; and srs-SCS is subcarrier spacing for SRS.

TABLE 5

| | |
|---|---|
| CLI-ResourceConfig ::= | SEQUENCE { |
| cli-ResourceConfigId | CLI-ResourceConfigId, |

RSSI-ResourceListConfigCLI ::= SEQUENCE (SIZE (1.. maxNrofCLI-RSSI-Resources)) OF
RSSI-ResourceConfigCLI

| RSSI-ResourceConfigCLI ::= | SEQUENCE { | |
|---|---|---|
| rssi-ResourceId | RSSI-ResourceId, | |
| rssi-SCS | SubcarrierSpacing, | |
| startPRB | INTEGER (0..2169), | |
| nrofPRBs | INTEGER (4..maxNrofPhysicalResourceBlocksPlus1), | |
| startPosition | INTEGER (0..13), | |
| nrofSymbols | INTEGER (1..14), | |
| rssi-PeriodicityAndOffset | RSSI-PeriodicityAndOffset, | |
| refServCellIndex | ServCellIndex | OPTIONAL, -- Need S |

...
}

| | |
|---|---|
| RSSI-ResourceId ::= | INTEGER (0.. maxNrofCLI-RSSI-Resources-1) |
| RSSI-PeriodicityAndOffset ::= | CHOICE { |
| sl10 | INTEGER(0..9), |
| sl20 | INTEGER(0..19), |
| sl40 | INTEGER(0..39), |
| sl80 | INTEGER(0..79), |
| sl160 | INTEGER(0..159), |
| sl320 | INTEGER(0..319), |
| s1640 | INTEGER(0..639), |

```
    ...
  }
```

Here, nrofPRBs is allowed size of the measurement BW; nrofSymbols is number of slots within a slot that is configured for CLI-RSSI measurement (the UE measures the RSSI from startPosition to startPosition+nrofSymbols−1); refServCellIndex is the index of the reference serving cell; rssi-PeriodicityAndOffset is periodicity and slot offset for this CLI-RSSI resource (if it is periodic or semi-persistent); rssi-SCS is reference subcarrier spacing for CLI-RSSI measurement; startPosition is OFDM symbol location of the CLI-RSSI resource within a slot; and startPRB is the starting PRB index of the measurement bandwidth.

TABLE 6

| | |
|---|---|
| CLI-ResourceConfig ::= | SEQUENCE { |
| cli-ResourceConfigId | CLI-ResourceConfigId, |
| cli-ResourceSetList | CHOICE { |

...

| | |
|---|---|
| cli-srs-ResourceSetList | SEQUENCE (SIZE (1..maxNrofCLI-SRS-ResourceSetsPerConfig)) |

OF CLI-SRS-ResourceSetId

| | |
|---|---|
| cli-rssi-ResourceSetList | SEQUENCE (SIZE (1..maxNrofCLI-RSSI-ResourceSetsPerConfig)) |

OF CLI-RSSI-ResourceSetId
},

| | |
|---|---|
| bwp-Id | BWP-Id, |
| resourceType | ENUMERATED { aperiodic, semiPersistent, periodic }, |

...,
}

| | |
|---|---|
| CLI-SRS-ResourceSet ::= | SEQUENCE { |
| cli-srs-ResourceSetId | CLI-SRS-ResourceSetId, |
| cli-srs-ResourceIdList | SEQUENCE (SIZE(1..maxNrofCLI-SRS-ResourcesPerSet)) |
| OF SRS-ResourceId | OPTIONAL, -- Cond Setup |
| resourceType | CHOICE { |
| aperiodic | SEQUENCE { ... }, |
| semi-persistent | SEQUENCE { ... }, |
| periodic | SEQUENCE { ... }, |

}

| | |
|---|---|
| CLI-SRS-ResourceSet ::= | SEQUENCE { |
| cli-srs-ResourceSetId | CLI-SRS-ResourceSetId, |
| cli-srs-ResourceIdList | SEQUENCE (SIZE(1..maxNrofCLI-SRS-ResourcesPerSet)) |
| OF SRS-ResourceId | OPTIONAL, -- Cond Setup |
| resourceType | CHOICE { |
| aperiodic | SEQUENCE { ... }, |
| semi-persistent | SEQUENCE { ... }, |
| periodic | SEQUENCE { ... }, |

}

In one example, the link between K RS(s) and CLI is based on an IE CSI-ReportConfig that includes information about K RSs, and reportQuantity set to a layer (L1) CLI metric. An example is shown in Table 7 when the measurement RS(s) are SRS or/and RSSI resources, as explained herein. In one example, the reportQuantity is set to SRI-RSRP indicating a SRS resource indicator (SRI) and L1-RSRP as the CLI metric. In one example, the reportQuantity is set to CLI-RSSI indicating a RSSI resource indicator (RRI) and L1-RSSI as the CLI metric.

TABLE 7

| CSI-ReportConfig ::= | SEQUENCE { | |
|---|---|---|
| reportConfigId | CSI-ReportConfigId, | |
| carrier | ServCellIndex | OPTIONAL, |

| resourcesForCLIMeasurement | CLI-ResourceConfigId, |
|---|---|
| reportConfigType | CHOICE { |
| periodic | SEQUENCE { ... }, |
| semiPersistentOnPUCCH | SEQUENCE { ... }, |
| semiPersistentOnPUCCH | SEQUENCE { ... }, |
| aperiodic | SEQUENCE { ... } |
| }, | |
| reportQuantity | CHOICE { ... |
| SRI-RSRP | NULL, |
| RRI-RSSI | NULL, |

},
RRI: RSSI resource indicator
SRI: SRS resource indicator

In one example, the UE is indicated/triggered with a CSI trigger (e.g. via a code point of the CSI request field in a DCI such as UL-DCI granting UL transmission) that triggers an aperiodic (AP) CLI reporting. In one example, the trigger message is received via a DCI (e.g. CSI request field in an UL-related DCI or a CSI request field in a DL-related DCI or a CSI request field in a dedicated or special purpose DCI that is different from DL-related DCI or UL-related DCI). Here, DCI-related DCI corresponds to a DCI (format) that allocates DL PDSCH assignment, and UL-related DCI corresponds to a DCI (format) that grants UL PUSCH transmission.

For instance, the CSI-AperiodicTriggerStateList IE can be used to configure the UE with a list of aperiodic trigger states, where each codepoint of the DCI field “CSI request” is associated with one trigger state. Upon reception of the value associated with a trigger state for CLI reporting, the UE will perform measurement of SRS or CLI-RSSI resource(s) and aperiodic reporting on L1 according to entries in the associatedReportConfigInfoList for that trigger state. An example is shown in Table 8.

TABLE 8

| | |
|---|---|
| CSI-AperiodicTriggerStateList ::= | SEQUENCE (SIZE (1..maxNrOfCSI-AperiodicTriggers)) OF |

CSI-AperiodicTriggerState

| | |
|---|---|
| CSI-AperiodicTriggerState ::= | SEQUENCE { |
| associatedReportConfigInfoList | SEQUENCE |

(SIZE(1..maxNrofReportConfigPerAperiodicTrigger)) OF CSI-AssociatedReportConfigInfo,
...,
}
CSI-AssociatedReportConfigInfo ::= SEQUENCE {

| | |
|---|---|
| reportConfigId | CSI-ReportConfigId, |

```
  ...
    }
```

In one example, when the CLI includes L1-RSRP, the reported L1-RSRP value(s) is defined according to at least one of the following examples.
In one example, the L1-RSRP value is defined by a B₁-bit value in the range [A_{1,L}, A_{1,H}] dBm with s₁ dB step size. In one example, B₁=7, A_{1,L}=−140, A_{1,H}=−44, and s₁=1. An example of the mapping of measured quantity is defined in Table 9.
In one example, when N>1, a differential L1-RSRP based reporting is used, where the largest measured value of L1-RSRP is quantized to a B₁-bit value in the range [A_{1,L}, A_{1,H}] dBm with s₁ dB step size, and each of the N−1 differential L1-RSRP values is quantized to a C₁-bit value. The differential L1-RSRP value is computed with t₁ dB step size with a reference to the largest measured L1-RSRP value which is part of the same L1-RSRP reporting instance. In one example, B₁=7, A_{1,L}=−140, A_{1,H}=−44, and s₁=1. In one example, C₁=4 and t₁=2. An example of the mapping of measured quantity is defined in Table 9 and Table 10.

TABLE 9
RSRP measurement report mapping

| Reported | Measured quantity | |
|---|---|---|
| value | value (L1-RSRP) | Unit |
| RSRP_0 | RSRP < −140 | dBm |
| RSRP_1 | −140 ≤ RSRP < −139 | dBm |
| RSRP_2 | −139 ≤ RSRP < −138 | dBm |
| . . . | | . . . |
| RSRP_95 | −46 ≤ RSRP < −45 | dBm |
| RSRP_96 | −45 ≤ RSRP < −44 | dBm |
| RSRP_97 | −44 ≤ RSRP | dBm |

TABLE 10
Differential L1-RSRP measurement
(for L1 reporting) report mapping

| | Measured quantity value | |
|---|---|---|
| Reported | (difference in measured | |
| value | RSRP from strongest RSRP) | Unit |
| DIFFRSRP_0 | 0 ≥ ΔRSRP > −2 | dB |
| DIFFRSRP_1 | −2 ≥ ΔRSRP > −4 | dB |
| DIFFRSRP_2 | −4 ≥ ΔRSRP > −6 | dB |
| DIFFRSRP_3 | −6 ≥ ΔRSRP > −8 | dB |
| DIFFRSRP_4 | −8 ≥ ΔRSRP > −10 | dB |
| DIFFRSRP_5 | −10 ≥ ΔRSRP > −12 | dB |
| DIFFRSRP_6 | −12 ≥ ΔRSRP > −14 | dB |
| DIFFRSRP_7 | −14 ≥ ΔRSRP > −16 | dB |
| DIFFRSRP_8 | −16 ≥ ΔRSRP > −18 | dB |
| DIFFRSRP_9 | −18 ≥ ΔRSRP > −20 | dB |
| DIFFRSRP_10 | −20 ≥ ΔRSRP > −22 | dB |
| DIFFRSRP_11 | −22 ≥ ΔRSRP > −24 | dB |
| DIFFRSRP_12 | −24 ≥ ΔRSRP > −26 | dB |
| DIFFRSRP_13 | −26 ≥ ΔRSRP > −28 | dB |
| DIFFRSRP_14 | −28 ≥ ΔRSRP > −30 | dB |
| DIFFRSRP_15 | −30 ≥ ΔRSRP | dB |

In one example, when the CLI includes L1-RSSI, the reported L1-RSSI value(s) is defined according to at least one of the following examples.
In one example, the L1-RSSI value is defined by a B₂-bit value in the range [A_{2,L}, A_{2,H}] dBm with s₂ dB step size. In one example, B₂=7, A_{2,L}=−100, A_{2,H}=−25, and s₂=1. An example of the mapping of measured quantity is defined in Table 11.
In one example, when N>1, a differential L1-RSSI based reporting is used, where the largest measured value of L1-RSSI is quantized to a B₂-bit value in the range [A_{2,L}, A_{2,H}] dBm with s₂ dB step size, and each of the N−1 differential L1-RSSI values is quantized to a C₂-bit value. The differential L1-RSSI value is computed with t₂ dB step size with a reference to the largest measured L1-RSSI value which is part of the same L1-RSSI reporting instance. In one example, B₂=7,A_{2,L}=−100, A_{2,H}=−25, and s₂=1. In one example, C₂=4 and t₂=2. An example of the mapping of measured quantity is defined in Table 11 and Table 10 (with ΔRSRP being replaced with ΔRSSI, and DIFFRSRP being replaced with DIFFTSSI).

TABLE 11
RSSI measurement report mapping

| Reported | | |
|---|---|---|
| value | Measured quantity value | Unit |
| CLI-RSSI_00 | CLI-RSSI < −100 | dBm |
| CLI-RSSI_01 | −100 ≤ CLI-RSSI < −99 | dBm |
| CLI-RSSI_02 | −99 ≤ CLI-RSSI < −98 | dBm |
| . . . | . . . | . . . |
| CLI-RSSI_74 | −27 ≤ CLI-RSSI < −26 | dBm |
| CLI-RSSI_75 | −26 ≤ CLI-RSSI < −25 | dBm |
| CLI-RSSI_76 | −25 ≤ CLI-RSSI | dBm |

In one example, a UE (e.g., the UE 116) is configured with a CLI reporting band (i.e., a set of PRBs) for CLI reporting, where the CLI reporting band is according to at least one of the following examples.
In one example, the CLI reporting band includes one or more than one PRBs.
In one example, the CLI reporting band includes UL PRB(s)/SB(s) in the duplex slot(s)/symbol(s).
In one example, the CLI reporting band includes all of or a subset of UL PRB(s)/SB(s) in the duplex slot(s)/symbol(s).

In one example, CLI reporting band is equal to PRB allocation of the K measurement RS(s). In one example, the CLI reporting band can be within (hence can be a subset of) PRB allocation of the K measurement RS(s).

In one example, at least one of the following examples is used/configured regarding the FD granularity of the CLI reporting (within the CLI reporting band).
In one example, the FD granularity is wideband (WB), i.e., one CLI value is reported for the entire CLI reporting band.
In one example, the FD granularity is SB, i.e., one CLI value is reported for each SB in the CLI reporting band. The SB size (in number of PRBs) can be fixed (e.g. 2 or 4 or 8) or configured (e.g. via RRC). Or, the SB size can be the same as SB size for CQI reporting. Or, the SB size can be the same as PRG size for PDSCH/PUSCH.
In one example, the FD granularity is WB+SB (differential reporting) w.r.t. a WB reference value. That is, one WB CLI value is reported, and one differential SB CLI value is reported for each SB in the CLI reporting, where each differential CQI value is w.r.t. the WB CQI value.
In one example, the FD granularity is fixed, e.g. according to one or more examples described herein. In one example, one of the examples herein is configured via higher layer parameter cliFormatIndicator. In one example, cliFormatIndicator takes a value from {WB, SB}, where WB corresponds to one or more examples described herein and SB corresponds to one or more examples described herein.
In one example, the FD granularity is reported by the UE. This reporting can be via UE capability reporting, wherein the UE reports the one or multiple FD granularities that it supports (when configured, the FD granularity is configured subject to the UE capability reporting). Or, this reporting can be via a CLI report (either separate or together with another CLI report). In this case, a two-part UCI can be used and an information about the FD granularity is included in UCI part 1.
In one example, the number of CLI values (denoted as X) is configured. When X=1, the CLI is according to one or more examples described herein. When X>1, the CLI is according to one or more examples described herein.

FIG. 26 illustrates examples of CLI report triggers 2600 according to embodiments of the present disclosure. For example, CLI report triggers 2600 can be triggered by any of the UEs 111-116 of FIG. 1, such as the UE 116. This example is for illustration only and other embodiments can be used without departing from the scope of the present disclosure.

In one example, the UE initiates/triggers the CLI measurement/reporting by transmitting a message/request to the NW. The message/request acts as a trigger (e.g. which indicates a CSI-TriggerState) for the AP reporting of the CLI report. In one example, the message/request is via a layer 1 signaling such as scheduling request (SR) or UCI. In this example, higher layer RRC (or/and MAC CE) is used to configure (and activate) one or more than one AP CLI/CSI trigger states, and SR/UCI with the message/request acts as a trigger (without any indication from NW). The UL resource allocation (RA) for CLI/CSI report can be pre-configured (CG PUSCH), or granted after the UE-initiated trigger/request is received.

In one example, in response to the UE-initiated trigger, the UE receives an ACK (e.g. 1-bit in DCI), and then performs measurement and reporting of the CLI report. In one example, the message/request is via a layer 1 signaling such as scheduling request (SR) or UCI. In this example, higher layer RRC (or/and MAC CE) is used to configure (and activate) one or more than one AP CLI/CSI trigger states, and SR/UCI with the message/request acts as a trigger or activator and the ACK from the NW allows/initiates the CLI/CSI reporting procedure. The UL resource allocation (RA) for CLI/CSI report can be pre-configured (CG PUSCH), or granted (e.g. together with ACK).

In a variation of the previous example, a first DCI can dynamically change/adapt information about the measurement (e.g. number of ports, power level etc.) associated with the CLI report, but does not trigger the CLI report. The trigger is UE-initiated. The NW can ACK in response to the UE-initiated trigger/request via a second DCI, and then the UE measures and reports the CLI report according to the latest update (if any) of the CLI/CSI Trigger state (via the first DCI). In one example, the first DCI and the second DCI are the same. In one example, they can be different.

In one example, the CLI report can be based on a configuration/trigger from the NW (i.e., NW-controlled) or a trigger from the (i.e. UE-initiated). The details of the trigger are as described in this disclosure. When NW-controlled, the UE calculates/reports the report in response to the reception of the trigger/configuration. When UE-initiated, the UE detects/decides a need for the report, transmits the trigger followed by the report (e.g. after receiving UL resources for the report) or transmits the report (when there is UL resources already allocated for the report).

In one example, for AP CLI report, a code point of a field in a DCI (e.g. UL-related DCI) can be used to trigger the AP CLI report, where the offset between the time slot carrying the DCI with the trigger and the start (time slot for the measurement) is provided via higher layer (RRC) or the DCI. An example is shown in left side of FIG. 26.

In one example, for AP CLI report, a UE-initiated trigger can be used to trigger the AP CLI report, where the offset between the time slot carrying the DCI with the trigger and the start (time slot for the measurement) is provided via higher layer (RRC) or the DCI. An example is shown in right side of FIG. 26.

In one embodiment, a UE is configured with a set of RE(s) linked (or associated) with a CLI. In one example, the set of RE(s) are RE(s) that the UE is configured to mute (not used to transmit UL), and CLI is (or determined) based on the set of muted RE(s). In one example, the muted RE(s) are PUSCH RE(s), i.e., REs belonging to a resource allocation (PRBs) for PUSCH. In one example, the muted REs can be restricted, e.g. to be within certain RE(s) or/and symbol(s) in a PRB of a slot. For instance, the restriction can be up to X RE(s) or/and up to Y symbols where the value of X or/and Y can be fixed or configured. In one example, the muted REs corresponds to a T-F pattern in a PRB of a slot. The number of candidate T-F patterns can be fixed (e.g. 1). In one example, the T-F pattern corresponds to an existing pattern such as T-F pattern of CSI-IM, or SRS, or ZP CSI-RS, or NZP CSI-RS. In one example, PUSCH REs are rate-matched around the muted REs. In one example, the muted RE(s) are restricted to UL symbols that do not carry UL DMRS, or UCI, or HARQ-ACK, or SR. In one example, the muted RE(s) are restricted to UL symbols carrying UL data.

In one example, the set of muted REs is configured via RRC. For a configured-grant (CG) PUSCH, the set of muted REs can be included in CG-PUSCH configuration. For a dynamic UL grant (via DCI), the muted REs can be configured via PUSCH-Config, or UL-DCI providing UL grant for PUSCH transmission.

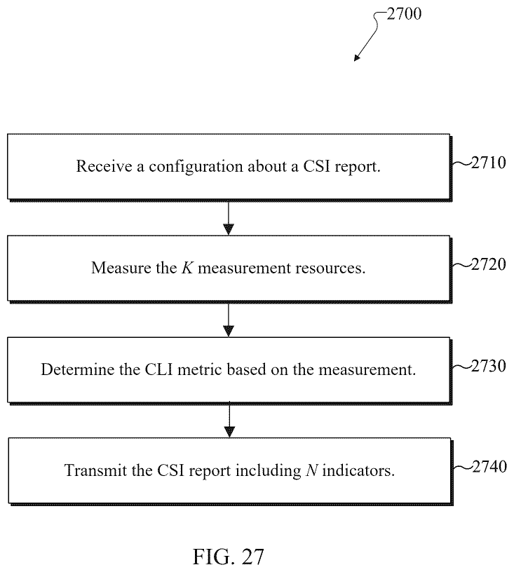

FIG. 27 illustrates an example method 2700 performed by a UE in a wireless communication system according to embodiments of the present disclosure. The method 2700 of FIG. 27 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2700 is for illustration only and other embodiments can be used without departing from the scope of the present disclosure.

The method 2700 begins with the UE receiving a configuration about a CSI report (2710). For example, in 2710, the configuration includes information about K measurement resources and a report quantity where K>1 and the report quantity corresponds to a CLI metric.

The UE then measures the K measurement resources (2720). For example, in 2720, each of the K measurement resources is a SRS resource or a RSSI measurement resource. The CLI metric is a L1 SRS-RSRP value when each of the K measurement resources is the SRS resource or a L1 CLI-RSSI value when each of the K measurement resources is the RSSI measurement resource. In various embodiments, the K measurement resources belong to a CSI resource set. The UE then determines the CLI metric based on the measurement (2730).

The UE then transmits the CSI report including N indicators (2740). For example, in 2740, each of the N indicators indicating a respective value of the CLI metric and N>1. In various embodiments, when K>1, the report quantity corresponds to a MRI, and the CSI report includes N MRIs, each of the N MRIs indicating a respective measurement resource from the K measurement resources and being associated with a respective one of the N indicators. In various embodiments, the configuration includes a value of N.

In various embodiments, when N=1, the L1 SRS-RSRP value reported is defined by a 7-bit value in a range [−140, −44] dBm with a 1 dB step size, according to a table (e.g., Table 9) disclosed herein. The L1 CLI-RSSI value reported is defined by a 7-bit value in a range [−100, −25] dBm with a 1 dB step size, according to a table (e.g., Table 11) disclosed herein.

In various embodiments, the UE performs a differential L1 SRS-RSRP based reporting where a largest measured value of L1 SRS-RSRP is quantized to a 7-bit value in a range [−140, −44] dBm with a 1 dB step size, and each of N−1 differential L1 SRS-RSRPs is quantized to a 4-bit value, and values for the N−1 differential L1 SRS-RSRPs are computed with 2 dB step size with a reference to the largest measured L1 SRS-RSRP value which is part of a same L1 SRS-RSRP reporting instance. The UE performs a differential L1 CLI-RSSI based reporting where a largest measured value of L1 CLI-RSSI is quantized to a 7-bit value in a range [−100, −25] dBm with a 1 dB step size, and each of N−1 differential L1 CLI-RSSIs is quantized to a 4-bit value, and values for the N−1 differential L1 CLI-RSSIs are computed with 2 dB step size with a reference to the largest measured L1 CLI-RSSI value which is part of a same L1 CLI-RSSI reporting instance. In various embodiments, the N−1 differential L1 SRS-RSRP values are according to a table (e.g., Table 10) disclosed herein.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive a configuration about a channel state information (CSI) report, the configuration including information about K measurement resources and a report quantity, where K≥1 and the report quantity corresponds to a cross-link interference (CLI) metric; and
a processor operably coupled to the transceiver, the processor, based on the configuration, configured to:
measure the K measurement resources, and
determine the CLI metric based on the measurement,
wherein the transceiver is further configured to transmit the CSI report including N indicators, each of the N indicators indicating a respective value of the CLI metric,
wherein:
N≥1,
each of the K measurement resources is one of a sounding reference signal (SRS) resource or a received signal strength indicator (RSSI) measurement resource, and
the CLI metric is (i) a layer 1 (L1) SRS-reference signal receive power (RSRP) value when each of the K measurement resources is the SRS resource or (ii) a L1 CLI-RSSI value when each of the K measurement resources is the RSSI measurement resource.

2. The UE of claim 1, wherein, when K>1:
the report quantity corresponds to a pair including the CLI metric and a measurement resource indicator (MRI), and
the CSI report includes a pair including the N indicators and N MRIs, each of the N MRIs indicating a respective measurement resource from the K measurement resources and being associated with a respective one of the N indicators.

3. The UE of claim 1, wherein the configuration includes a value of N.

4. The UE of claim 1, wherein, when N=1:
the L1 SRS-RSRP value reported is defined by a 7-bit value in a range [−140, −44] dBm with a 1 dB step size, according to the following table:

| Reported | | |
|---|---|---|
| value | Measured quantity value | Unit |
| RSRP_0 | RSRP < −140 | dBm |
| RSRP_1 | −140 ≤ RSRP < −139 | dBm |
| RSRP_2 | −139 ≤ RSRP < −138 | dBm |
| . . . | . . . | . . . |
| RSRP_95 | −46 ≤ RSRP < −45 | dBm |
| RSRP_96 | −45 ≤ RSRP < −44 | dBm |
| RSRP_97 | −44 ≤ RSRP | dBm |

and
the L1 CLI-RSSI value reported is defined by a 7-bit value in a range [−100, −25] dBm with a 1 dB step size, according to the following table:

| Reported | | |
|---|---|---|
| value | Measured quantity value | Unit |
| RSRP_0 | RSRP < −140 | dBm |
| RSRP_1 | −140 ≤ RSRP < −139 | dBm |
| RSRP_2 | −139 ≤ RSRP < −138 | dBm |
| . . . | | . . . |
| RSRP_95 | −46 ≤ RSRP < −45 | dBm |
| RSRP_96 | −45 ≤ RSRP < −44 | dBm |
| RSRP_97 | −44 ≤ RSRP | dBm |

5. The UE of claim 1, wherein, when N>1, the transceiver is further configured to perform:
a differential L1 SRS-RSRP based reporting, wherein:
a largest measured value of L1 SRS-RSRP is quantized to a 7-bit value in a range [−140, −44] dBm with a 1 dB step size, and each of N−1 differential L1 SRS-RSRPs is quantized to a 4-bit value, and
values for the N−1 differential L1 SRS-RSRPs are computed with 2 dB step size with a reference to the largest measured L1 SRS-RSRP value which is part of a same L1 SRS-RSRP reporting instance; and
a differential L1 CLI-RSSI based reporting, wherein:
a largest measured value of L1 CLI-RSSI is quantized to a 7-bit value in a range [−100, −25] dBm with a 1 dB step size, and each of N−1 differential L1 CLI-RSSIs is quantized to a 4-bit value, and
values for the N−1 differential L1 CLI-RSSIs are computed with 2 dB step size with a reference to the largest measured L1 CLR-RSSS value which is part of a same L1 CL-RSSI reporting instance.

6. The UE of claim 5, wherein the N−1 differential L1 SRS-RSRP values are according to the following table:

| | Measured quantity value | |
|---|---|---|
| Reported | (difference in measured | |
| value | RSRP from strongest RSRP) | Unit |
| DIFFRSRP_0 | 0 ≥ ΔRSRP > −2 | dB |
| DIFFRSRP_1 | −2 ≥ ΔRSRP > −4 | dB |
| DIFFRSRP_2 | −4 ≥ ΔRSRP > −6 | dB |
| DIFFRSRP_3 | −6 ≥ ΔRSRP > −8 | dB |
| DIFFRSRP_4 | −8 ≥ ΔRSRP > −10 | dB |
| DIFFRSRP_5 | −10 ≥ ΔRSRP > −12 | dB |
| DIFFRSRP_6 | −12 ≥ ΔRSRP > −14 | dB |
| DIFFRSRP_7 | −14 ≥ ΔRSRP > −16 | dB |
| DIFFRSRP_8 | −16 ≥ ΔRSRP > −18 | dB |
| DIFFRSRP_9 | −18 ≥ ΔRSRP > −20 | dB |
| DIFFRSRP_10 | −20 ≥ ΔRSRP > −22 | dB |
| DIFFRSRP_11 | −22 ≥ ΔRSRP > −24 | dB |
| DIFFRSRP_12 | −24 ≥ ΔRSRP > −26 | dB |
| DIFFRSRP_13 | −26 ≥ ΔRSRP > −28 | dB |
| DIFFRSRP_14 | −28 ≥ ΔRSRP > −30 | dB |
| DIFFRSRP_15 | −30 ≥ ΔRSRP | dB |

7. The UE of claim 1, wherein the K measurement resources belong to a CSI resource set.

8. A base station (BS) comprising:
a processor; and
a transceiver operably coupled to the processor, the transceiver configured to:
transmit a configuration about a channel state information (CSI) report, the configuration including information about K measurement resources and a report quantity, where K≥1 and the report quantity corresponds to a cross-link interference (CLI) metric; and
receive the CSI report including N indicators, each of the N indicators indicating a respective value of the CLI metric, the CLI metric based on the K measurement resources, and
wherein:
N≥1,
each of the K measurement resources is one of a sounding reference signal (SRS) resource or a received signal strength indicator (RSSI) measurement resource, and
the CLI metric is (i) a layer 1 (L1) SRS-reference signal receive power (RSRP) value when each of the K measurement resources is the SRS resource or (ii) a L1 CLI-RSSI value when each of the K measurement resources is the RSSI measurement resource.

9. The BS of claim 8, wherein, when K>1:
the report quantity corresponds to a pair including the CLI metric and a measurement resource indicator (MRI), and
the CSI report includes a pair including the N indicators and N MRIs, each of the N MRIs indicating a respective measurement resource from the K measurement resources and being associated with a respective one of the N indicators.

10. The BS of claim 8, wherein the configuration includes a value of N.

11. The BS of claim 8, wherein, when N=1:
the L1 SRS-RSRP value reported is defined by a 7-bit value in a range [−140, −44] dBm with a 1 dB step size, according to the following table:

| Reported | | |
|---|---|---|
| value | Measured quantity value | Unit |
| RSRP_0 | RSRP < −140 | dBm |
| RSRP_1 | −140 ≤ RSRP < −139 | dBm |
| RSRP_2 | −139 ≤ RSRP < −138 | dBm |
| . . . | | . . . |
| RSRP_95 | −46 ≤ RSRP < −45 | dBm |
| RSRP_96 | −45 ≤ RSRP < −44 | dBm |
| RSRP_97 | −44 ≤ RSRP | dBm |

and
the L1 CLI-RSSI value reported is defined by a 7-bit value in a range [−100, −25] dBm with a 1 dB step size, according to the following table:

| Reported | | |
|---|---|---|
| value | Measured quantity value | Unit |
| RSRP_0 | RSRP < −140 | dBm |
| RSRP_1 | −140 ≤ RSRP < −139 | dBm |
| RSRP_2 | −139 ≤ RSRP < −138 | dBm |
| . . . | | . . . |
| RSRP_95 | −46 ≤ RSRP < −45 | dBm |
| RSRP_96 | −45 ≤ RSRP < −44 | dBm |
| RSRP_97 | −44 ≤ RSRP | dBm |

12. The BS of claim 8, wherein, when N>1, the transceiver is further configured to receive:
a differential L1 SRS-RSRP based reporting, wherein:
a largest measured value of L1 SRS-RSRP is quantized to a 7-bit value in a range [−140, −44] dBm with a 1 dB step size, and each of N−1 differential L1 SRS-RSRPs is quantized to a 4-bit value, and
values for the N−1 differential L1 SRS-RSRPs are computed with 2 dB step size with a reference to the largest measured L1 SRS-RSRP value which is part of a same L1 SRS-RSRP reporting instance; and
a differential L1 CLI-RSSI based reporting, wherein:
a largest measured value of L1 CLI-RSSI is quantized to a 7-bit value in a range [−100, −25] dBm with a 1 dB step size, and each of N−1 differential L1 CLI-RSSIs is quantized to a 4-bit value, and
values for the N−1 differential L1 CLI-RSSIs are computed with 2 dB step size with a reference to the largest measured L1 CLI-RSSI value which is part of a same L1 CLI-RSSI reporting instance.

13. The BS of claim 12, wherein the N−1 differential L1 SRS-RSRP values are according to the following table:

| | Measured quantity value | |
|---|---|---|
| Reported | (difference in measured | |
| value | RSRP from strongest RSRP) | Unit |
| DIFFRSRP_0 | 0 ≥ ΔRSRP > −2 | dB |
| DIFFRSRP_1 | −2 ≥ ΔRSRP > −4 | dB |
| DIFFRSRP_2 | −4 ≥ ΔRSRP > −6 | dB |
| DIFFRSRP_3 | −6 ≥ ΔRSRP > −8 | dB |
| DIFFRSRP_4 | −8 ≥ ΔRSRP > −10 | dB |
| DIFFRSRP_5 | −10 ≥ ΔRSRP > −12 | dB |
| DIFFRSRP_6 | −12 ≥ ΔRSRP > −14 | dB |
| DIFFRSRP_7 | −14 ≥ ΔRSRP > −16 | dB |
| DIFFRSRP_8 | −16 ≥ ΔRSRP > −18 | dB |
| DIFFRSRP_9 | −18 ≥ ΔRSRP > −20 | dB |
| DIFFRSRP_10 | −20 ≥ ΔRSRP > −22 | dB |
| DIFFRSRP_11 | −22 ≥ ΔRSRP > −24 | dB |
| DIFFRSRP_12 | −24 ≥ ΔRSRP > −26 | dB |
| DIFFRSRP_13 | −26 ≥ ΔRSRP > −28 | dB |
| DIFFRSRP_14 | −28 ≥ ΔRSRP > −30 | dB |
| DIFFRSRP_15 | −30 ≥ ΔRSRP | dB |

14. The BS of claim 8, wherein the K measurement resources belong to a CSI resource set.

15. A method performed by a user equipment (UE), the method comprising:
receiving a configuration about a channel state information (CSI) report, the configuration including information about K measurement resources and a report quantity, where K≥1 and the report quantity corresponds to a cross-link interference (CLI) metric;
measuring the K measurement resources;
determining the CLI metric based on the measurement; and
transmitting the CSI report including N indicators, each of the N indicators indicating a respective value of the CLI metric,
wherein:
N≥1,
each of the K measurement resources is one of a sounding reference signal (SRS) resource or a received signal strength indicator (RSSI) measurement resource, and
the CLI metric is (i) a layer 1 (L1) SRS-reference signal receive power (RSRP) value when each of the K measurement resources is the SRS resource or (ii) a L1 CLI-RSSI value when each of the K measurement resources is the RSSI measurement resource.

16. The method of claim 15, wherein, when K>1:
the report quantity corresponds to a pair including the CLI metric and a measurement resource indicator (MRI), and
the CSI report includes a pair including the N indicators and N MRIs, each of the N MRIs indicating a respective measurement resource from the K measurement resources and being associated with a respective one of the N indicators.

17. The method of claim 15, wherein the configuration includes a value of N.

18. The method of claim 15, wherein, when N=1:
the L1 SRS-RSRP value reported is defined by a 7-bit value in a range [−140, −44] dBm with a 1 dB step size, according to the following table:

| Reported | | |
|---|---|---|
| value | Measured quantity value | Unit |
| RSRP_0 | RSRP < −140 | dBm |
| RSRP_1 | −140 ≤ RSRP < −139 | dBm |
| RSRP_2 | −139 ≤ RSRP < −138 | dBm |
| . . . | | . . . |
| RSRP_95 | −46 ≤ RSRP < −45 | dBm |
| RSRP_96 | −45 ≤ RSRP < −44 | dBm |
| RSRP_97 | −44 ≤ RSRP | dBm |

and
the L1 CLI-RSSI value reported is defined by a 7-bit value in a range [−100, −25] dBm with a 1 dB step size, according to the following table:

| Reported | | |
|---|---|---|
| value | Measured quantity value | Unit |
| RSRP_0 | RSRP < −140 | dBm |
| RSRP_1 | −140 ≤ RSRP < −139 | dBm |
| RSRP_2 | −139 ≤ RSRP < −138 | dBm |
| . . . | . . . | . . . |
| RSRP_95 | −46 ≤ RSRP < −45 | dBm |
| RSRP_96 | −45 ≤ RSRP < −44 | dBm |
| RSRP_97 | −44 ≤ RSRP | dBm |

19. The method of claim 15, further comprising, when N>1, performing:
a differential L1 SRS-RSRP based reporting, wherein:
a largest measured value of L1 SRS-RSRP is quantized to a 7-bit value in a range [−140, −44] dBm with a 1 dB step size, and each of N−1 differential L1 SRS-RSRPs is quantized to a 4-bit value, and
values for the N−1 differential L1 SRS-RSRPs are computed with 2 dB step size with a reference to the largest measured L1 SRS-RSRP value which is part of a same L1 SRS-RSRP reporting instance; and
a differential L1 CLI-RSSI based reporting, wherein:
a largest measured value of L1 CLI-RSSI is quantized to a 7-bit value in a range [−100, −25] dBm with a 1 dB step size, and each of N−1 differential L1 CLI-RSSIs is quantized to a 4-bit value, and
values for the N−1 differential L1 CLI-RSSIs are computed with 2 dB step size with a reference to the largest measured L1 CLI-RSSI value which is part of a same L1 CLI-RSSI reporting instance.

20. The method of claim 19, wherein the N−1 differential L1 SRS-RSRP values are according to the following table:

| | Measured quantity value | |
|---|---|---|
| Reported | (difference in measured | |
| value | RSRP from strongest RSRP) | Unit |
| DIFFRSRP_0 | 0 ≥ ΔRSRP > −2 | dB |
| DIFFRSRP_1 | −2 ≥ ΔRSRP > −4 | dB |
| DIFFRSRP_2 | −4 ≥ ΔRSRP > −6 | dB |
| DIFFRSRP_3 | −6 ≥ ΔRSRP > −8 | dB |
| DIFFRSRP_4 | −8 ≥ ΔRSRP > −10 | dB |
| DIFFRSRP_5 | −10 ≥ ΔRSRP > −12 | dB |
| DIFFRSRP_6 | −12 ≥ ΔRSRP > −14 | dB |
| DIFFRSRP_7 | −14 ≥ ΔRSRP > −16 | dB |
| DIFFRSRP_8 | −16 ≥ ΔRSRP > −18 | dB |
| DIFFRSRP_9 | −18 ≥ ΔRSRP > −20 | dB |
| DIFFRSRP_10 | −20 ≥ ΔRSRP > −22 | dB |
| DIFFRSRP_11 | −22 ≥ ΔRSRP > −24 | dB |
| DIFFRSRP_12 | −24 ≥ ΔRSRP > −26 | dB |
| DIFFRSRP_13 | −26 ≥ ΔRSRP > −28 | dB |
| DIFFRSRP_14 | −28 ≥ ΔRSRP > −30 | dB |
| DIFFRSRP_15 | −30 ≥ ΔRSRP | dB |
